(19) United States
(12) Patent Application Publication
(10) Pub. No.: US 2009/0049161 A1
(43) Pub. Date: Feb. 19, 2009

(54) SERVER MANAGEMENT PROGRAM IN NETWORK SYSTEM

(75) Inventors: Susumu Takeuchi, Kawasaki (JP); Kenichi Nakano, Kawasaki (JP); Masahiro Chiba, Kawasaki (JP); Kei Nakata, Kawasaki (JP); Shunpei Nishikawa, Kawasaki (JP); Kaoru Miyamoto, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/236,270

(22) Filed: Sep. 23, 2008

Related U.S. Application Data
(63) Continuation of application No. PCT/JP2006/306429, filed on Mar. 29, 2006.

(51) Int. Cl. G06F 15/16

(52) U.S. Cl. 709/222; 709/223; 726/11

(57) ABSTRACT

(Purpose) To perform a dynamic network node management by dividing logically a network, with a physical connection being uniformly configured in a management of nodes over the network.

(Solving Means) In response to the inputting of a physical connection database storing a physical connection status related to apparatuses and a server, forming a network, a logical connection condition database storing a condition for a logical connection of the network, and a connection instruction of the logical connection of the network, an apparatus is caused to perform as path calculating means for calculating a path logically connectable from the physical connection database and the physical connection condition database, command generating means for generating a command for modifying, in response to the calculated path, setting to the corresponding apparatus or server, and transmitting means for transmitting the command for modifying the setting.

This application is a Continuation of International Application No. PCT/JP2006/306429 under 35 U.S.C. § 111(a), filed Mar. 29, 2006.

### TECHNICAL FIELD

The invention relates to an apparatus or a program for managing a state of a server and to a method for managing a state transition of the server in a virtual network management.

### BACKGROUND ART

As network systems currently become larger in scale, techniques for automatically registering and managing addition and disconnection of individual servers operating in the network system have been developed.

For example, Patent Document 1 discloses a communication system for notifying all apparatuses of a network address of one server when the server is newly added to an information processing system or for notifying all the servers of the network address of the server when a new communication apparatus is added.

The addition and disconnection of the server at the updating of current network configurations are limited to the case in which the server to be handled is physically connected to the network.

FIG. 35 illustrates a known network configuration.

As shown, a physical connection between servers in the known system configuration is disconnected by SLB, FW or SW on a per function basis of servers including an AP (application) server, a Web server, a DB (database) server, a load balancing server, etc. For this reason, a vast amount of process has been needed to update attributes of the servers.

For example, in order to use the Web server as an AP server, the Web server has needed to be physically disconnected from the network, and physically reconnected to a domain of the AP server. Further in order to use a pool server belonging to the Web server as a pool server belonging to the AP server, the physical connection has needed to be also reconnected. The known network configuration is not appropriate for application change.

Patent Document 1: Japanese Laid-open Patent Publication No. 2000-354062

### DISCLOSURE OF INVENTION

### Problems to be Solved by the Invention

In accordance with Patent Document 1, only a notification of a network address of a newly added server is issued, and a workload of an administrator for setting operation is not reduced.

If a backup server is prepared at each layer in the network configuration, the application of the server is determined on a per layer basis, and a flexible system configuration cannot be formed and updated. Also to shift a server beyond a layer, the server needs to be manually shifted. Setting the network is time consuming, and a setting error can be created. On the other hand, if the network is configured at a single layer, a problem that management of the network configuration becomes difficult is created.

The invention has been developed in view of the above problems, and it is an object of the invention to provide an management apparatus and a management program for reducing workload in management setting in addition and deletion of resources in the case in which the management setting is performed with a physical connection single-layered and a logical connection multi-layered. Also, a dynamic network node management can be performed with a tag VLAN employed in a node management over the network.

### Means for Solving the Problems

A management server is caused to perform, in response to the inputting of a physical connection database storing a physical connection status related to apparatuses and a server, forming the network, a logical connection condition database storing a condition for a logical connection of the network, and a connection instruction of the logical connection of the network, as path calculating means for calculating a path logically connectable from the physical connection condition database and the physical connection database, command generating means for generating a command for modifying, in response to the calculated path, setting to the corresponding apparatus or server, and transmitting means for transmitting the command for modifying the setting.

Also, if the apparatuses forming the network includes a relay apparatus, in a network system in which the network forms a different LAN with an identifier attached thereto during information transmission, after a completion notification notifying of copy ending is received from the server, identification information of the particular LAN for data transmission and reception in accordance with the identifier, is notified to the server, and an instruction to switch the replay process with the server to the LAN by the identifier and the identification information are output to the relay apparatus connected to the server.

Further, the LAN to which the identifier is attached is a tag VLAN.

Further, a verification of the physical connection status with the server is performed when the server is included in a backup server group.

Further, the apparatuses forming the network includes a load balancing apparatus, and detecting means is further included, the detecting means detecting the load balancing apparatus responding to a logical connection instruction if the logical connection instruction to map the server to the load balancing apparatus is input.

The apparatuses forming the network includes a firewall apparatus, and detecting means is further included, the detecting means detecting the firewall apparatus responding to a logical connection instruction if the logical connection instruction to let any server to pass the firewall apparatus is input.

### (Advantages)

The network configuration of the invention is managed with at a single layer on the physical connection and logically at a multi-layer.

### BRIEF DESCRIPTION OF THE DRAWINGS

FIG. 1 is a configuration diagram of a network system of the invention.

FIG. 2 illustrates a state of a physical connection of a network configuration of the present embodiment.

FIG. 3 illustrates a node information table 500 registering information related to each node.

FIG. 4 illustrates a relationship of a site 220, a category and a domain.

FIG. 5 is a flowchart illustrating a process of the physical connection of from a node registration to a physical connection registration.

FIG. 6 illustrates a physical connection table.

FIG. 7 illustrates a mapping table mapping a server domain 180 to a network domain 240.

FIG. 8 illustrates a relationship of the connection of the server domain 180 and the network domain 240 in registration results of the physical connection.

FIG. 9 illustrates a registration screen of a management program.

FIG. 10 is a table of connection rules.

FIG. 11 is a table of setting conditions of a new object.

FIG. 12 illustrates a control structure of the management program.

FIG. 13A, FIG. 13B, FIG. 13C, and FIG. 13D are flowcharts illustrating how a network logical configuration is formed.

FIG. 14A, FIG. 14B, and FIG. 14C are flowcharts illustrating how the network logical configuration is formed.

FIG. 15 illustrates a setting information example 550 registered for a subnet object and transmitted.

FIG. 16 illustrates a setting information example 560 registered for SLB within a routine object and transmitted.

FIG. 17 illustrates information of a physical link.

FIG. 18 illustrates a screen example related to a load balancing relation specified on an object registration screen 600.

FIG. 19 is a flowchart illustrating a setting process related to load balancing.

FIG. 20 illustrates a structure example 560 of the setting information to be transmitted to an SLB 40 apparatus.

FIG. 21 is a flowchart in which there is an increase or a decrease in the number of the servers contained in a server group 200.

FIG. 22 is a flowchart illustrating a pass permission setting between a server group to FW and an external network.

FIG. 23 illustrates a network configuration screen example during a pass permission setting between external networks.

FIG. 24 illustrates an information example to be transmitted to a target FW 50.

FIG. 25 illustrates a screen example during the pass permission setting between sub groups 200.

FIG. 26 illustrates a setting example performed to FW 50.

FIG. 27A and FIG. 27B illustrates a management structure of the servers.

FIG. 28 illustrates a network connection in which a blade server 80 is used.

FIG. 29 illustrates a control structure of a management program switching between VLAN and tag VLAN.

FIG. 30 is a sequence chart of a sub boot at the tag VLAN.

FIG. 31 is an operational flowchart in which switching to the tag VLAN is performed.

FIG. 32 illustrates a state in which the server verifies connection.

FIG. 33 illustrates a state in which the server is registered in a pool group 190.

FIG. 34 illustrates a state in which the server is registered in a service VLAN by the tag VLAN.

FIG. 35 illustrates a known network configuration.

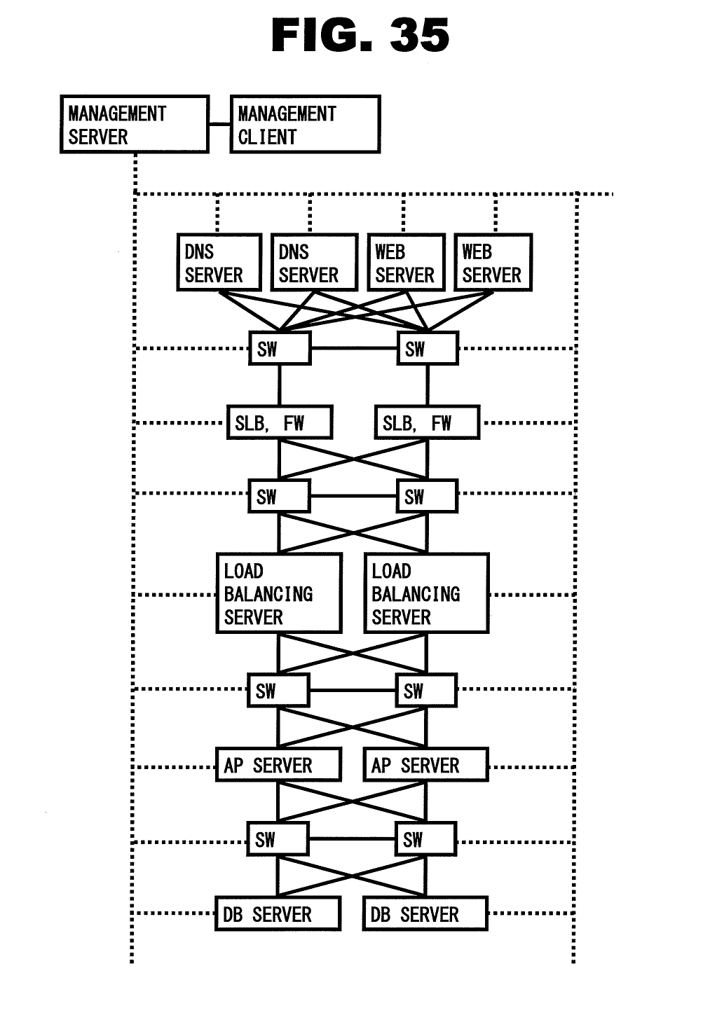

FIG. 36 illustrates a hardware configuration of a management server 10 of FIG. 1.

### BEST MODE FOR CARRYING OUT THE INVENTION

The embodiments of the invention are described below with reference to the drawings.

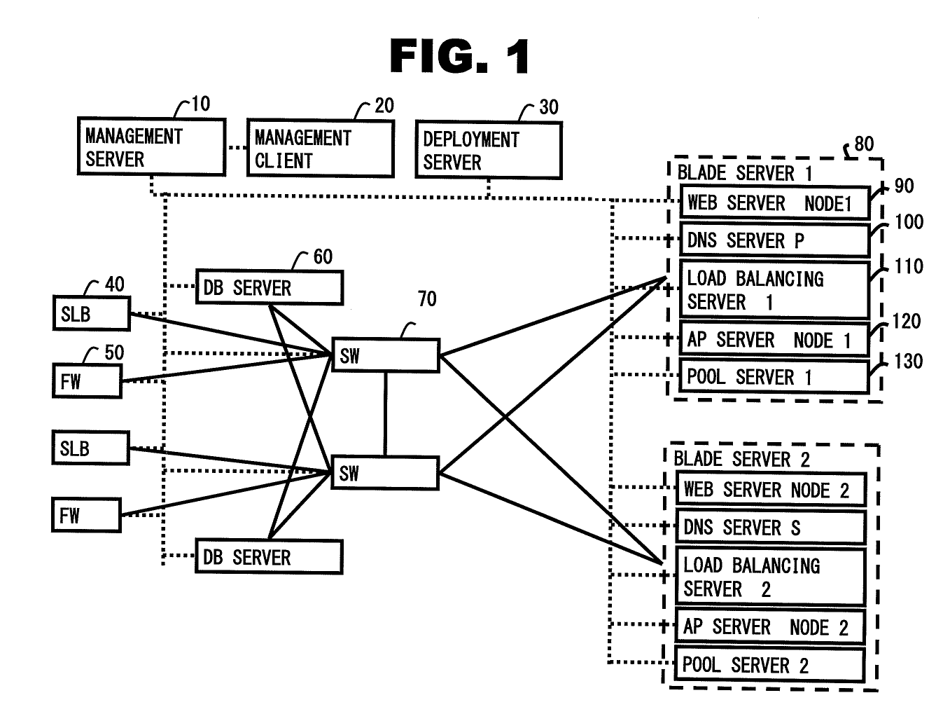

FIG. 1 is a configuration diagram of a network system handled in the invention.

As shown, a management server 10 is an apparatus managing each node of the network system. The node is an element forming the network. In this embodiment, servers including a DB server 60, a WEB server 90, an AP server 120, etc. and communication apparatuses including an SLB 40, a FW 50, a SW 70, etc. correspond to nodes. A connection between nodes is referred to as a link. In the link, a connection denoted by a solid line indicates a LAN for use in service or other application, and a connection denoted by a broken line indicates a management LAN (hereinafter referred to as a “management LAN”).

A management client 20 is a terminal to be operated by an administrator to operate the management server 10.

The SLB 40 (Server Load Balancer) is a load balancing apparatus of servers. The SLB 40 manages a received process request and transmits the process request to a plurality of servers as management targets within the network.

The FW 50 (Fire Wall) is an apparatus that prevents an unauthorized access from an external network and is communicable with a port authorized and defined beforehand.

The SW 70 (Layer 2 Switch) is a network relay apparatus that determines a destination of a packet according to data of a data link layer (second layer) and transmits the packet.

A DNS (Domain Name Server) server 100 is a server apparatus that converts a domain name as an identifier of a computer into an IP (Internet Protocol) address. The WEB server 90, a load balancing server, the AP server 120, and the DB server 60 are divided and managed by domain.

The WEB server 90 is a server that accumulates a variety of information and transmits these pieces of information via an external network such as the Internet.

A load balancing server 110 is a server apparatus that assigns a process to an appropriate AP server 120 in consideration of a traffic state of a plurality of AP servers 120 within the network.

The AP (application server) server 120 is a server apparatus that receives a request from a user via the WEB server 90 and performs a process of a service system.

The DB (Data Base) server 60 is a database server.

The pool server 130 is a server that is immediately usable when another operating server fails or when a server needs reinforcing in function.

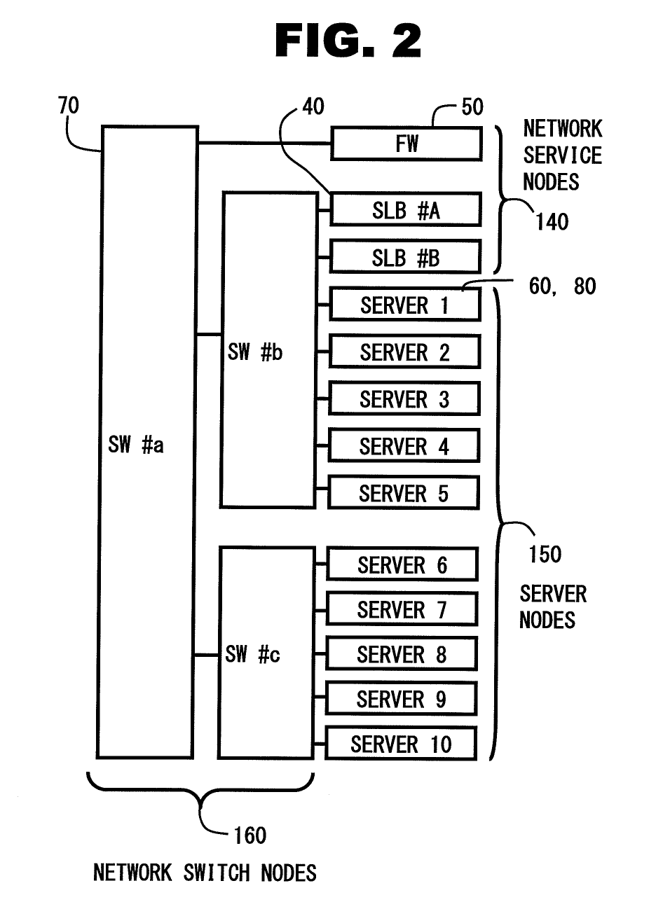

FIG. 2 illustrates a state of a physical connection of the network configuration of the embodiment. The configuration of the system is divided into and managed according to network switch nodes 160 serving as a base including the SW 70, and server nodes 150 and network service nodes 140 connected to each other for operation by the network switch nodes 160. As shown, the FW 50, SLB 40#A, and SLB 40#B are the network service nodes 140, server 1 through server 10 are the server nodes 150, and SW 70#a, SW 70#b, and SW 70#c are the network switch nodes 160. Information related to each node is registered beforehand on the management server 10.

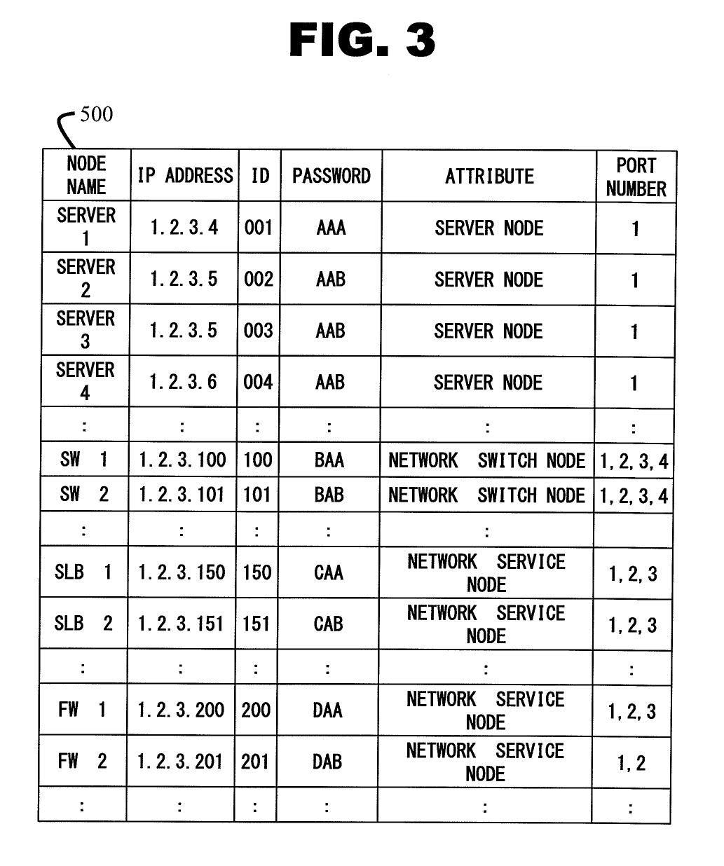

FIG. 3 is a node management table 500 registering thereon the information related to each node. The node management table 500 registers thereon on a per node basis a node name, an IP address, an ID, a password, attribute information, and a port number that each node has. The node name is information used to identify a server name, a SW 70 name, etc. The IP address is a connection destination address in the management LAN.

The ID and password are a login ID and password with respect to the corresponding node. The ID and password are used if needed to operate the node. The attribute is registered to indicate which node of the above-described node sorting the corresponding node belongs to.

When the node is registered, a list of ports installed on the node is also registered. The registration of a port allows the port to be used as a connection port during node physical connection. When the registration of each node is completed, information related to the physical connection thereof is registered.

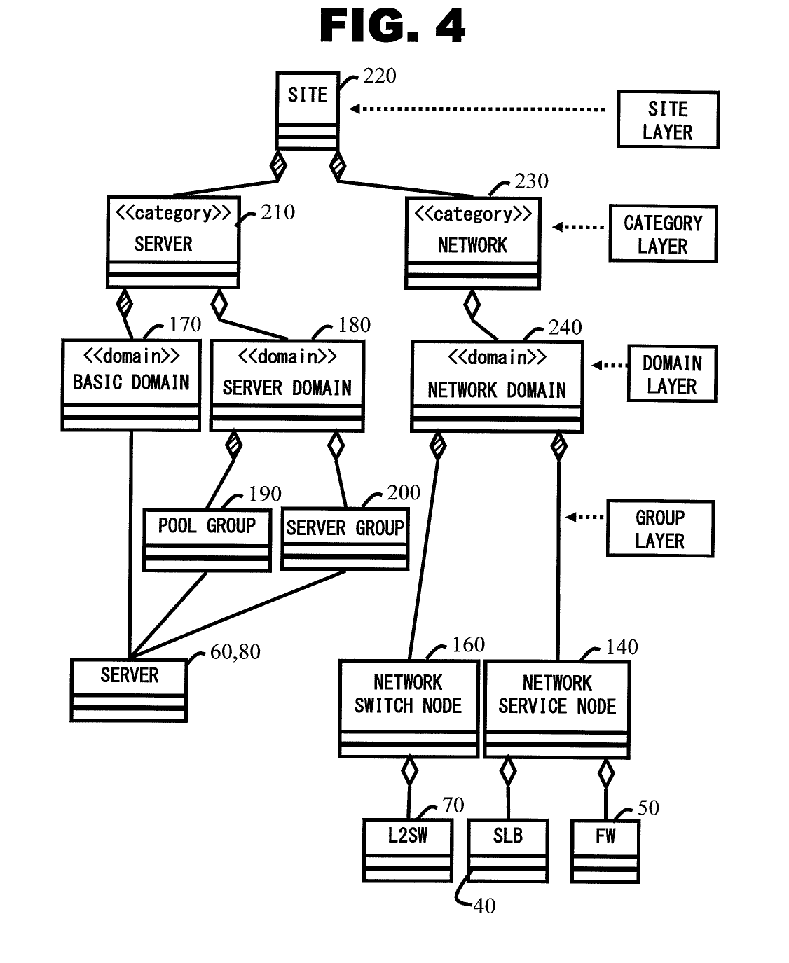

FIG. 4 illustrates a relationship of a site 220, a category, and a domain. A layer structure of the network system of the present embodiment is constructed of a site 220 layer, a category layer, a domain layer, and a group layer. The site 220 is a unit forming one service system. The site 220 has a server category 210 and a network category 230. The server category 210 has one basic domain 170 and a plurality of server domains 180. The server domains 180 have in turn a pool group 190 and a server group 200. The basic domain 170, the pool group 190, and the pool group 200 are mapped to the server nodes 150.

The network category 230 has a plurality of network domains 240, and the network domain 240 has one network switch node 160 and one network service node 140. The network switch node 160 is mapped to the SLB 40 and the FW 50 as previously discussed.

The network category 230 has no basic domain 170. The network category 230 directly registers a node in the network domain 240. Once the node is registered, a type of apparatus is identified using a technique such as SNMP (Simple Network Management Protocol), and the node is automatically sorted based on management information held by the apparatus as to whether the node is either the network switch node 160 or the network service nodes 140.

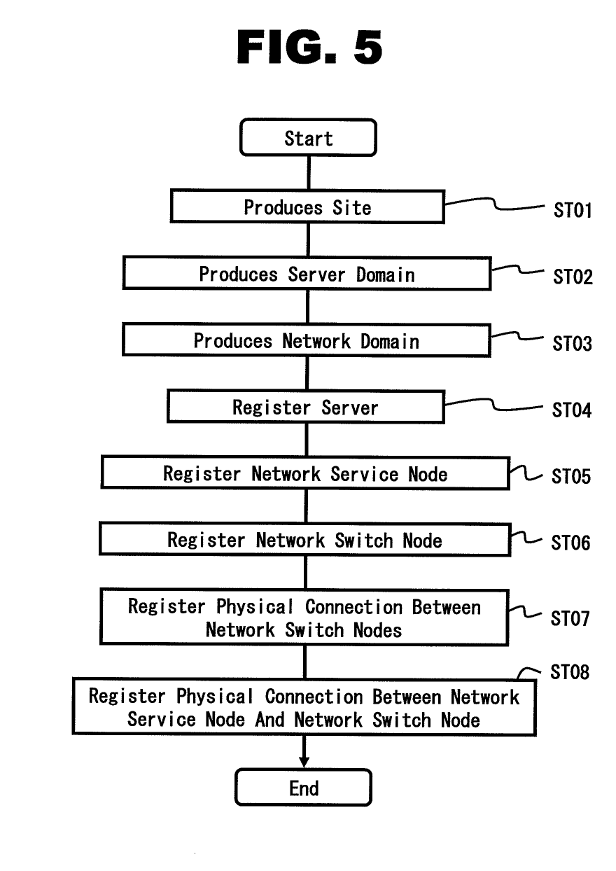

FIG. 5 is a flowchart illustrating a process of the physical connection of from a node registration to a physical connection registration. This process provides connection information matching actual physical connection.

The administrator newly produces the site 220 (ST01). In this case, the category layer is automatically produced. Next, the server domain 180 is produced (ST02). In this case, the basic domain 170 is also produced. Next, the network domain 240 is produced (ST03). Next, the server is registered in the server domain 180 (ST04). Next, the network service node 140 is registered (ST05). Next, the network switch node 160 is registered (ST06). Next, the physical connection between the network switch nodes 160, including the port numbers, are registered (ST07). Next, the physical connection between the network service node 140 and the network switch node 160, including the port numbers, are registered (ST08).

Through the above-described registration process, the physical connection of the system becomes recognizable by the management server 10. Further, as for the topology discovery function, the physical connection of a system can be automatically recognized in accordance with “Japanese Unexamined Patent Application Publication No. 2005-348051: Apparatus and Method for Discovering Topology of Network Apparatus.”

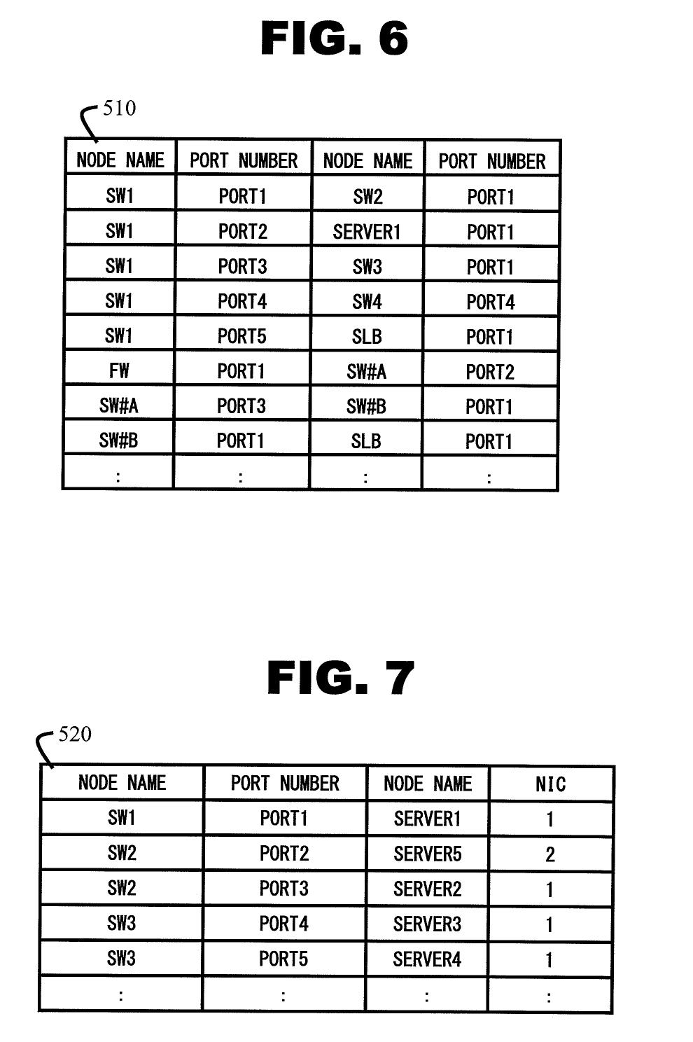

FIG. 6 is a physical connection table 510. The physical connection table 510 stores information mapped to information regarding a port-to-port connection of each node of the actual connection. The nodes and ports on the left side of the physical connection table 510 are mapped to the nodes and ports on the right side of the physical connection table 510.

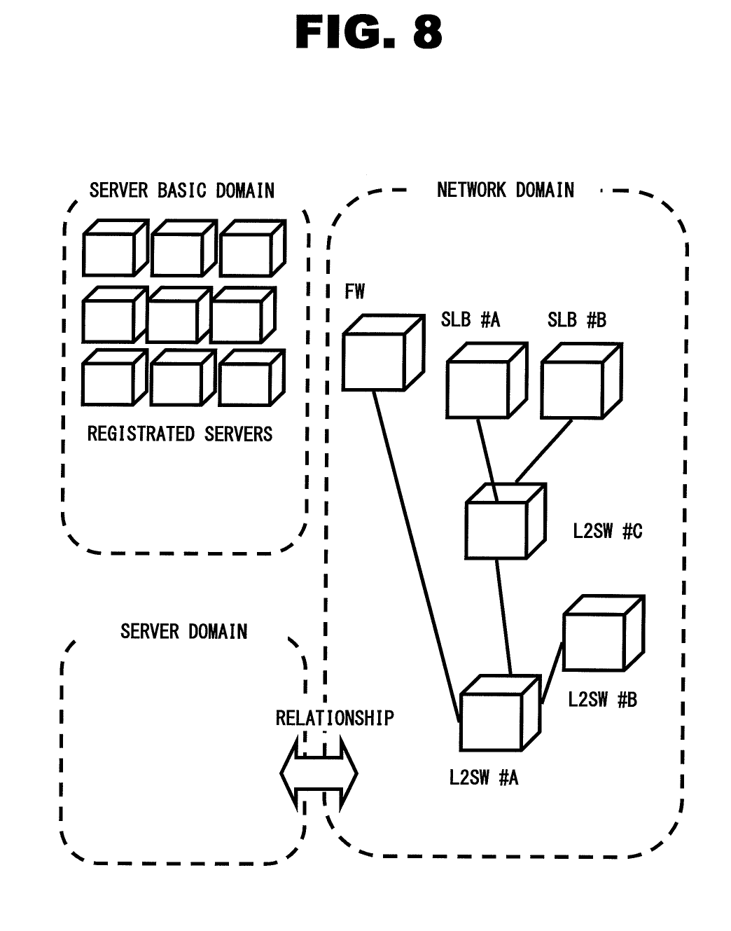

FIG. 7 is a mapping table 520 mapping the server domain 180 to the network domain 240. This lists ports of the SW 70 connected to the port of the server apparatus, extracted from the physical connection table 510.

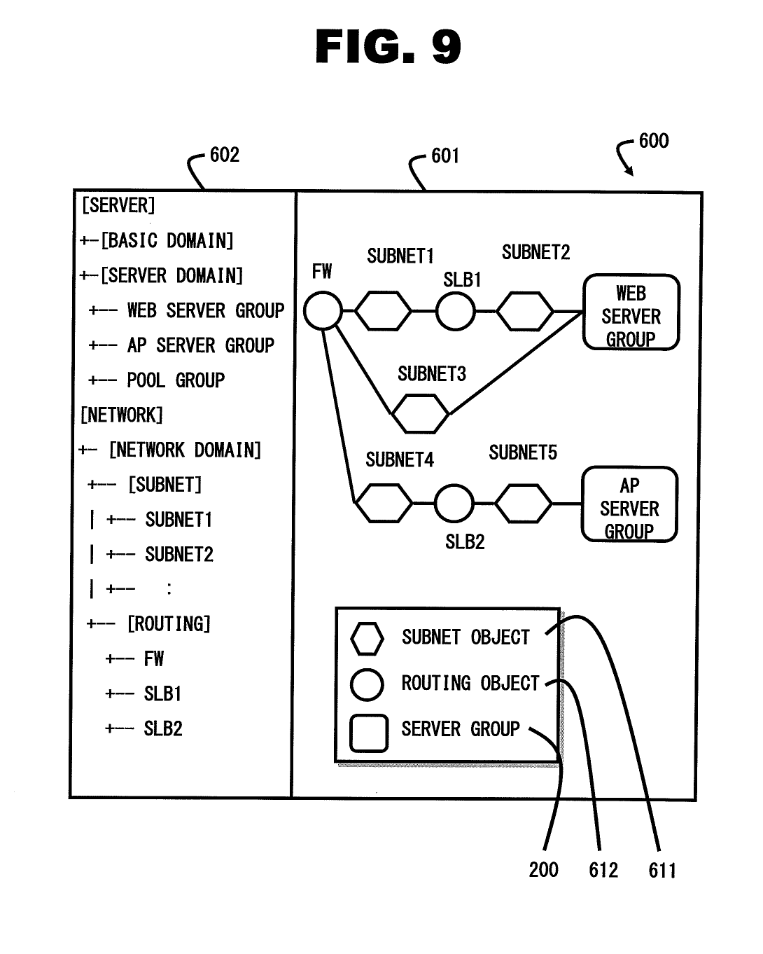

FIG. 8 illustrates a relationship of the connection of the server domain 180 and the network domain 204 in registration results of the physical connection. FIG. 8 shows a state that the connection information of the network domain 240 is completed and a state that the mapping of the server domains 180 to the network domain 240 is also completed. As described above, the registration process of the physical connection is completed.

Next, a logical configuration of the network is determined.

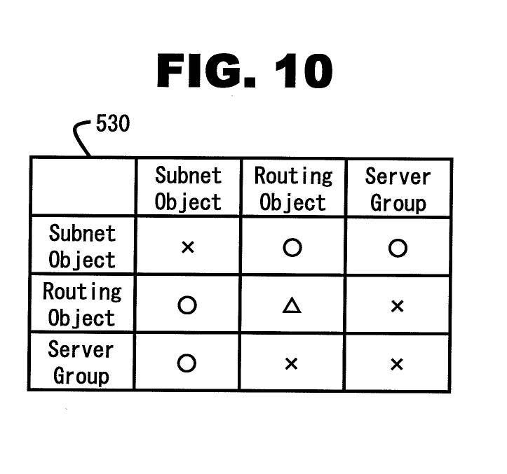

FIG. 9 a registration screen of a management program. If an object is newly produced on an object registration window 600 on the right portion of the screen, the produced object is displayed on a window 601 and also in logical configuration information 602 on the left portion of the screen. The administrator produces on the object registration window 600 the logical configuration of the network system to be produced. The network logical configuration on the object registration window 600 contains three types of data of a subnet object 611, a routing object 612, and a server group 200.

The routing object 612 indicates an object constructed of an apparatus having a function equal to or higher than Layer 3. Also, the routing object 612 contains attribute information indicating whether the routing object 612 is a mere router, an object implementing the server load balancing function (SLB), or an object implementing the firewall (FW). If the routing object 612 is registered as being nonredundant, a single network node belongs thereto, and if the routing object 612 is registered as being redundant, a plurality of network nodes belong thereto.

The subnet object 611 is a subnet based on VLAN extending between SWs 70, and the SW 70 belonging thereto dynamically changes.

The server group 200 is a group sorted according to function with each group composed of a plurality of servers. For example, servers are grouped into an AP server group, a WEB server group, etc. according to function.

The network logical configuration is generated by logically connecting these subnet object 611, routing object 612, and server group 200. A connection rule of the objects, and a connection rule between each object and each group are defined beforehand.

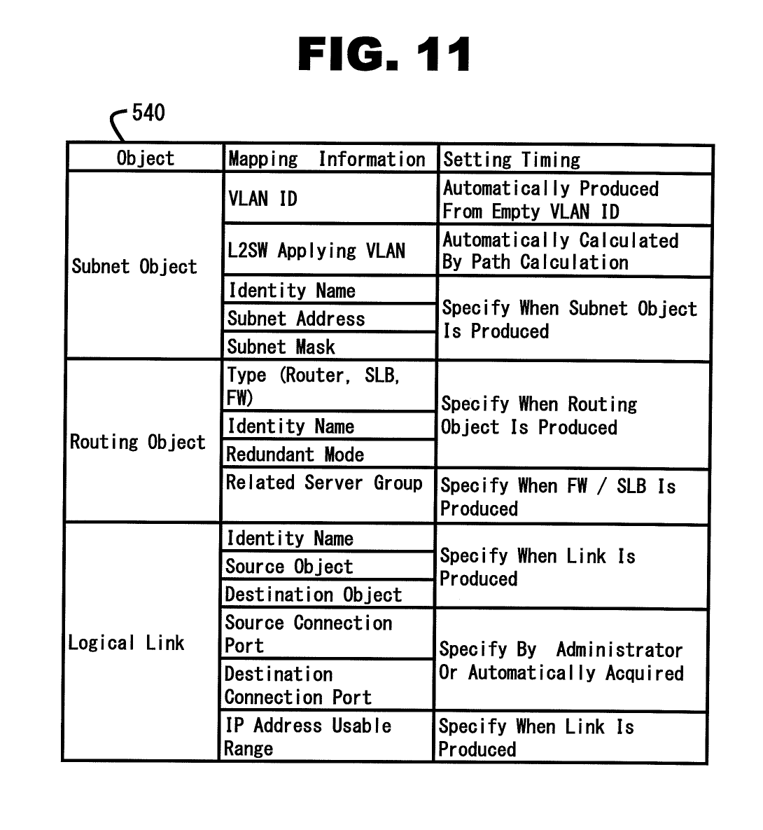

FIG. 10 is a table of a connection rule table 530. In accordance with the connection rule table 530, one subnet object 611 cannot be connected to another subnet object 611, the subnet object 611 can be connected to the routing object 612, and the subnet object 611 can be connected to the server group 200. Also, the connection rule table 530 defines conditions such as a condition that a direct connection between one routing object 612 and another routing object 612 can be possible only when functions are directly combined in an integrated type apparatus containing FW 50 and SLB 40 in an integrated fashion, and another condition that the routing object 612 cannot be connected to the server group 200. If each object is newly produced on the screen, information necessary for the network configuration related to that object needs to be registered in accordance with pre-defined setting.

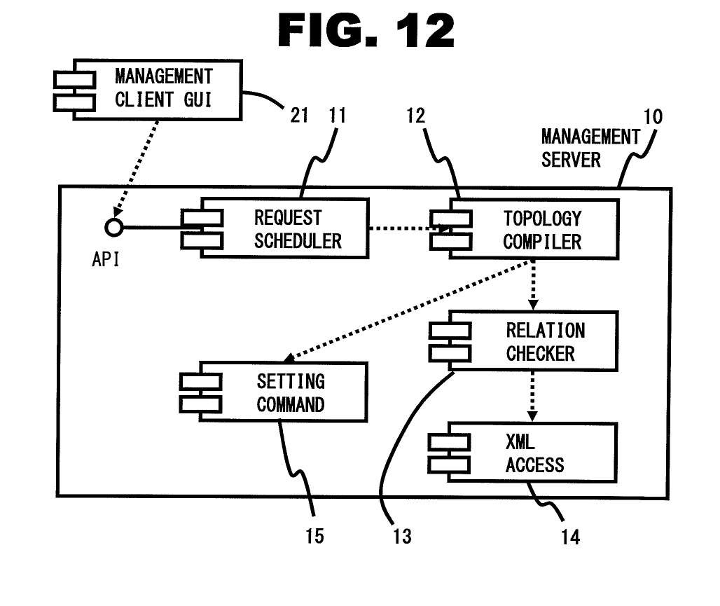

FIG. 11 is a setting condition table 540 of a new object. Data items of the setting condition table 540 include an object type, mapping information, and information setting timing.

The information necessary to map the subnet object 611 includes VLANID, SW 70 to which VLAN is applied, an identity name, a subnet address, and a subnet mask. The VLANID is automatically produced from an empty VLANID on the side of the management server 10, the SW 70 to which the VLAN is applied is automatically calculated on the side of the management server 10 in accordance with a path calculation, and the identity name, the subnet address and the subnet mask are specified by the administrator when the subnet object 611 is produced.

Information necessary to map the routing object 612 includes attribute information as to whether the routing object 612 is the SLB 40, the FW 50 or the router, an identity name identifying the object, a value of a redundant mode, and information of the related server group 200. The attribute information, the identity name information, and the redundant mode value are input when the routing object 612 is produced. The related server group 200 is specified when the FW 50 and the SLB 40 are produced.

Information necessary to map the logical link includes an identity name, a transmission source object, a transmission destination object, a transmission source connection port, a transmission destination connection port, and an IP address usable range. The identity name, the transmission source object, and the transmission destination object are specified by the administrator when the link is produced, and the transmission source connection port and the transmission destination connection port are specified by the administrator or automatically acquired. Also, the IP address usable range is specified by the administrator.

Under the above-described predefined conditions, the administrator registers the network logical configuration on a GUI screen of the network logical configuration displayed on the screen of the management client 20.

The management program of the management server 10 calculates configuration information to be actually set at each node based on the registered information of the physical configuration obtained in FIG. 5 and the logical configuration of FIG. 9, and then sets the configuration information at each node. Therefore, the user can control the actual configuration by simply giving an instruction to update the logical configuration without being aware of how each server and network control apparatuses are physically connected over the network.

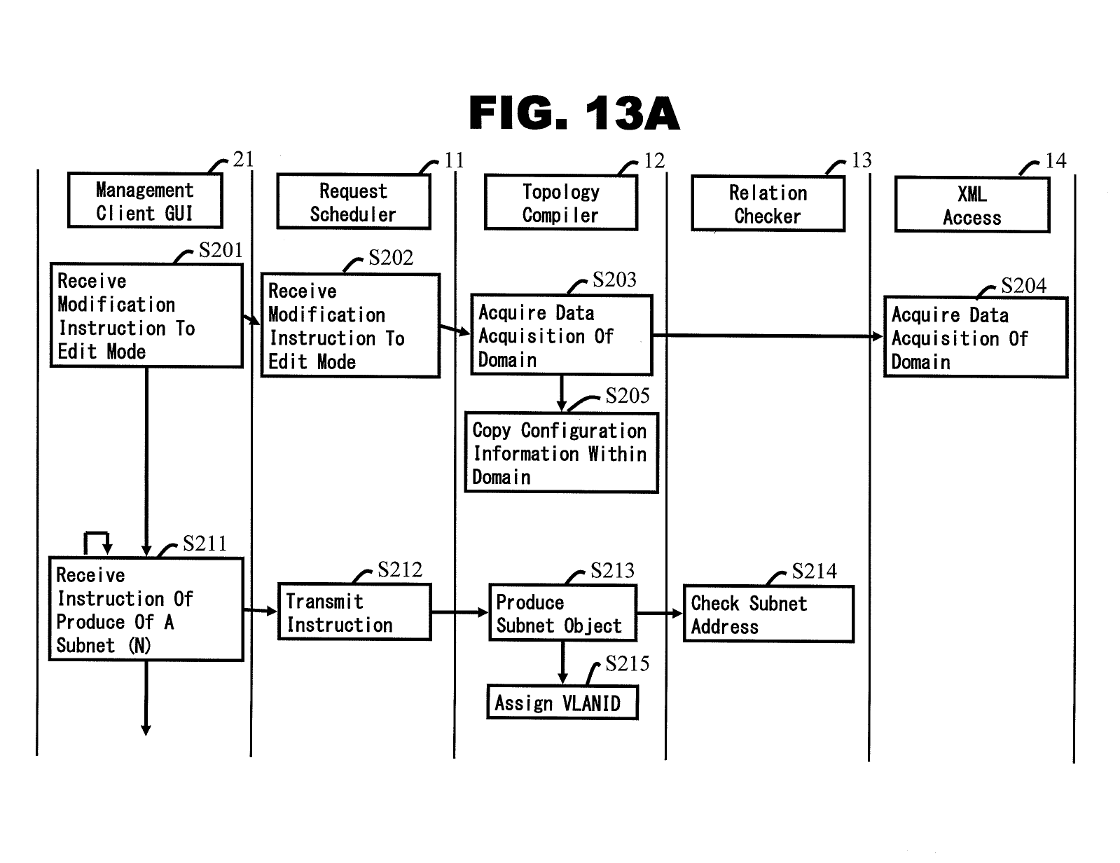

FIG. 12 illustrates a control structure of the management program. The control structure of the management program includes a request scheduler 11, a topology compiler 12, a relation checker 13, an XML access 14, and a setting command 15. A management client GUI 21 (Graphical User Interface) inputs information to the request scheduler 11 via an API (Application Program Interface).

The request scheduler 11 schedules the process request from the management client 20. If there are a plurality of different commands, the request scheduler 11 sets an appropriate order on the commands and then processes the commands.

The topology compiler 12 calculates the logical configuration. The topology compiler 12 performs a process as to which SW 70 the VLAN is to be set on and what route setting needs to be performed in order for the apparatus to be exactly connected in accordance with the logical configuration.

A routing object 612 directly stores information regarding which physical node corresponds thereto. The topology compiler 12 thus performs a process as to a static path to be set in the FW 50 in relation to the server group 200, a process relating to a modification in the assignment destination of the SLB 40, and other processes.

The topology compiler 12 performs in the calculations thereof in the following order by acquiring an edit right of the logical configuration, registering the logical object and producing the logical link, and then giving an instruction to reflect the settings performed. In accordance with the new configuration, the topology compiler 12 performs a final calculation.

The relation checker 13 determines the calculation results as to whether the physical connection has been performed. The management client GUI 21 is an interface screen displayed on a terminal on which the administrator inputs information. The XML access 14 accesses the configuration results of the network using XML (eXtensible Markup Language). The setting command 15 produces a command to modify each node setting based on the calculation results provided by the topology compiler 12, and transmits the command to each node.

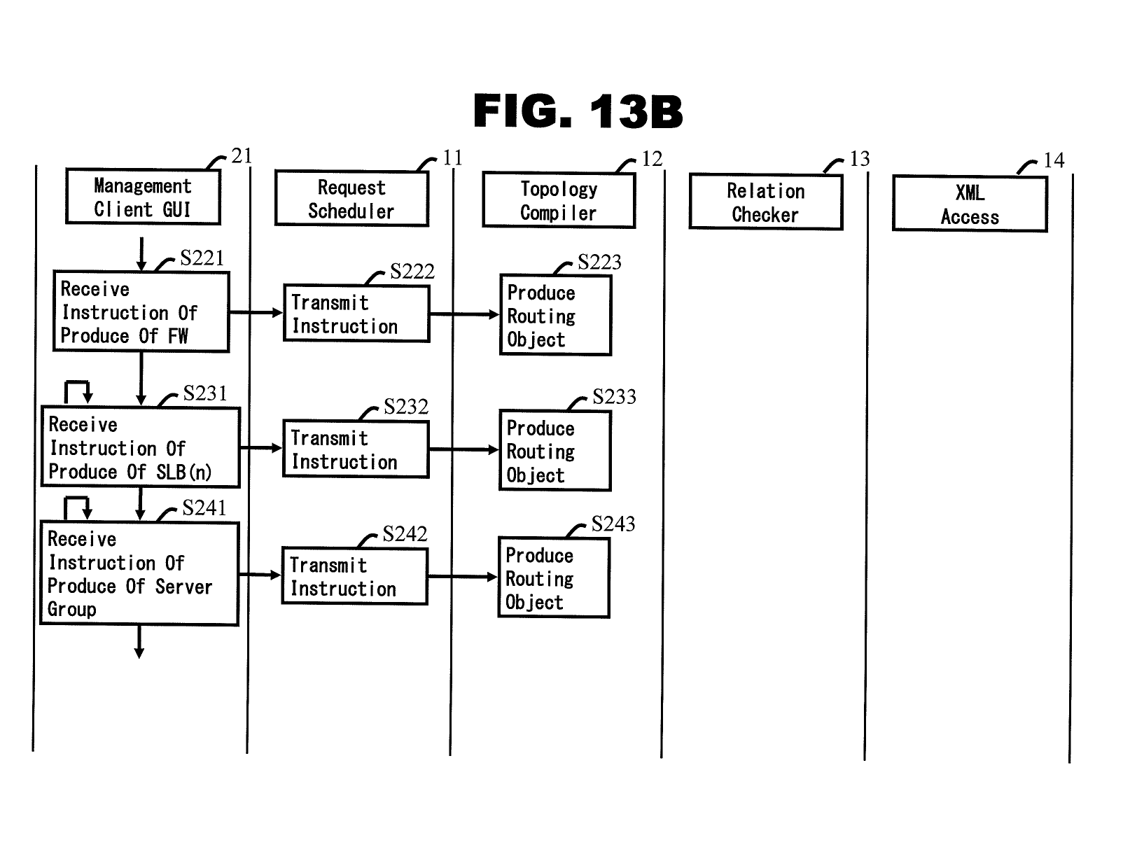

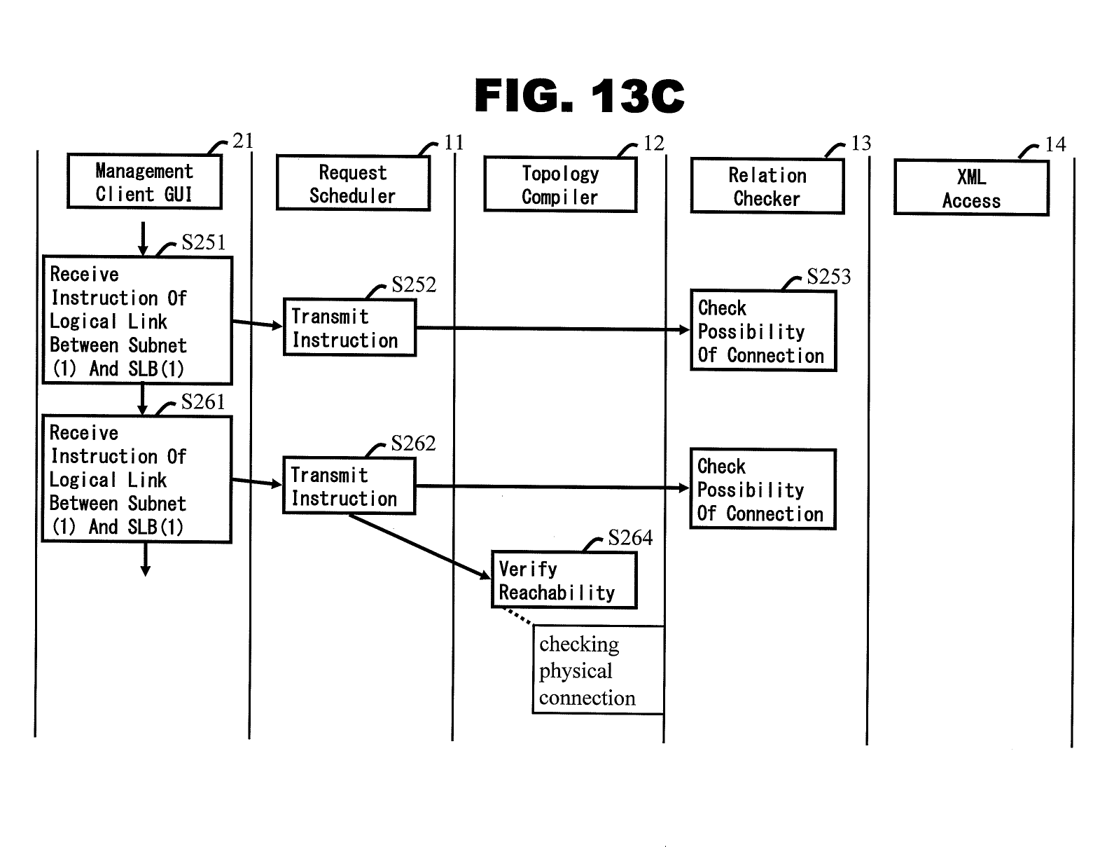

FIG. 13A, FIG. 13B, FIG. 13C, FIG. 13D, FIG. 14A, FIG. 14B, and FIG. 14C are flowcharts for actually producing the network logical configuration. The process for generating the logical configuration of the network of FIG. 9 is described below.

When a modification instruction to an edit mode of the network logical configuration is input from the management client GUI 21 (S201), an edit mode shifting instruction is transmitted to the request scheduler 11 in the management server 10 (S202), and acquisition information of the edit right is transmitted from the request scheduler 11 to the topology compiler 12 (S203). The topology compiler 12 acquires from the XML access 14 data acquisition of a domain as a current edit target (S204). The topology compiler 12 copies configuration information within the domain (S205).

If a subnet (n) (n represents a subnet number on a screen 601) is produced (S211), an instruction related to the subnet is transmitted to the topology compiler 12 via the request scheduler 11 (S212). The topology compiler 12 produces the subnet object 611 (S213) and assigns a VLANID to thereto (S215). This process is performed on all the subnet objects 611 on the screen 601. A subnet address is also checked (S214).

When an FW is produced (S221), the corresponding instruction is transferred to the topology compiler 12 via the request scheduler 11 (S222). The topology compiler 12 produces the routing object 612 (S223). This process is performed on the routing objects 612 of all the FWs on the screen 601.

If an SLB(n) (n represents an SLB number on the screen 601) is produced (S231), the corresponding instruction is transmitted to the topology compiler 12 via the request scheduler 11 (S232). The topology compiler 12 produces the routing object 612 (S233). This process is performed on the routing objects 612 of all the SLBs(n) on the screen 601.

If the server group 200 is produced (S241), the corresponding instruction is transferred to the topology compiler 12 via the request scheduler 11 (S242). The topology compiler 12 produces and registers the server group 200 (S243). This process is performed all the server groups 200 on the screen.

A process for the connection of objects displayed on the screen is preformed next.

A logical link is produced between the FW as the routing object 612 and a subnet (1) (S251), an instruction to produce the logical link is transmitted to the relation checker 13 via the request scheduler 11 (S252), and the relation checker 13 checks whether a connection is possible (S253).

A logical link is produced between the subnet (1) and an SLB(1) (S261), and an instruction to produce the logical link is transmitted to the relation checker 13 via the request scheduler 11 (S262). The relation checker 13 checks whether a connection is possible (S263). In order to determine whether a connection path is present on the physical connection, the topology compiler 12 verifies a reachability (S264).

The reachability is verified by checking the physical connection and finalizing the path in use when the subnet object 611 is connected to at least two routing objects 612. At the time point when the subnet object 611 is connected to one routing object 612, no path is produced. If the two routing objects 612 are connected, the network nodes of the respective routing objects 612 are connected via a VLAN. The VLAN is a substance of the subnet object 611.

A logical link is produced between the SLB(1) and a subnet (2) (S271), and an instruction to produce the logical link is transmitted to the relation checker 13 via the request scheduler 11 (S272). The relation checker 13 checks whether a connection is possible (S273).

A logical link is produced between the subnet (2) and a WEB server group (S281), and an instruction to produce the logical link is transferred to the relation checker 13 via the request scheduler 11 (S282). The relation checker 13 checks whether a connection is possible (S283). The topology compiler 12 verifies a reachability to determine whether a connection path is present on the physical connection (S284).

As illustrated in FIG. 14, a logical link is produced between the WEB server group and a subnet (3) (S301), and an instruction to produce the logical link is transferred to the relation checker 13 via the request scheduler 11 (S302). The relation checker 13 checks whether a connection is possible (S303).

A logical link is produced between the subnet (3) and the FW (S311), and an instruction to produce the logical link is transferred to the relation checker 13 via the request scheduler 11 (S312). The relation checker 13 checks whether a connection is possible (S313). Also, the topology compiler 12 verifies a reachability (S314).

A logical link is produced between the FW and a subnet (4) (S321), and an instruction to produce the logical link is transferred to the relation checker 13 via the topology compiler 12 (S322). The relation checker 13 determines whether a connection is possible (S323).

A logical link is produced between a subnet (4) and an SLB(2) (S331), and an instruction to produce the logical link is transferred to the relation checker 13 via the request scheduler 11 (S332). The relation checker 13 determines whether a connection is possible (S333). The topology compiler 12 verifies a reachability (S334).

An logical link is produced between the SLB(2) and a subnet (5) (S341), and the relation checker 13 determines whether a connection is possible (S342).

A logical link is produced between the subnet (5) and the AP group (S351), and an instruction to produce the logical link is transferred to the relation checker 13 via the request scheduler 11 (S352). The relation checker 13 determines whether a connection is possible (S353). Also, the topology compiler 12 verifies a reachability (S354).

When the production of the above-described logical links is completed and an instruction to reflect the settings is input from the management client GUI 21 (S361), the instruction to reflect the settings is transferred to the topology compiler 12 via the request scheduler 11 (S362). The topology compiler 12 performs a process to reflect the settings. More specifically, a path is re-calculated (S363), and the path information is stored on the XML access 14 (S364) (S367), and the setting command 15 is produced (S365), and then transmitted to each node via the request scheduler 11 (S366).

The process of path determination is performed by the topology compiler 12. The path determination process selects the shortest path. If a plurality of path candidates are available, an indication to that effect is output to an operator to allow the operator to select one of the path candidates. Alternatively, an algorithm may be incorporated to select successively the path candidates in order.

The path production of the VLAN is performed on the copy produced when the edit right is first acquired. For this reason, the operation of the system is continued with the state prior to edit starting maintained. When the instruction to reflect the settings is finally issued, the edited data is replaced with the current configuration information, and a difference is then reflected in the network apparatuses.

Further, to cancel the editing, copied data is discarded.

As described above, logical setting can be possible to the network domain 240 immediately before the port of the actual server node.

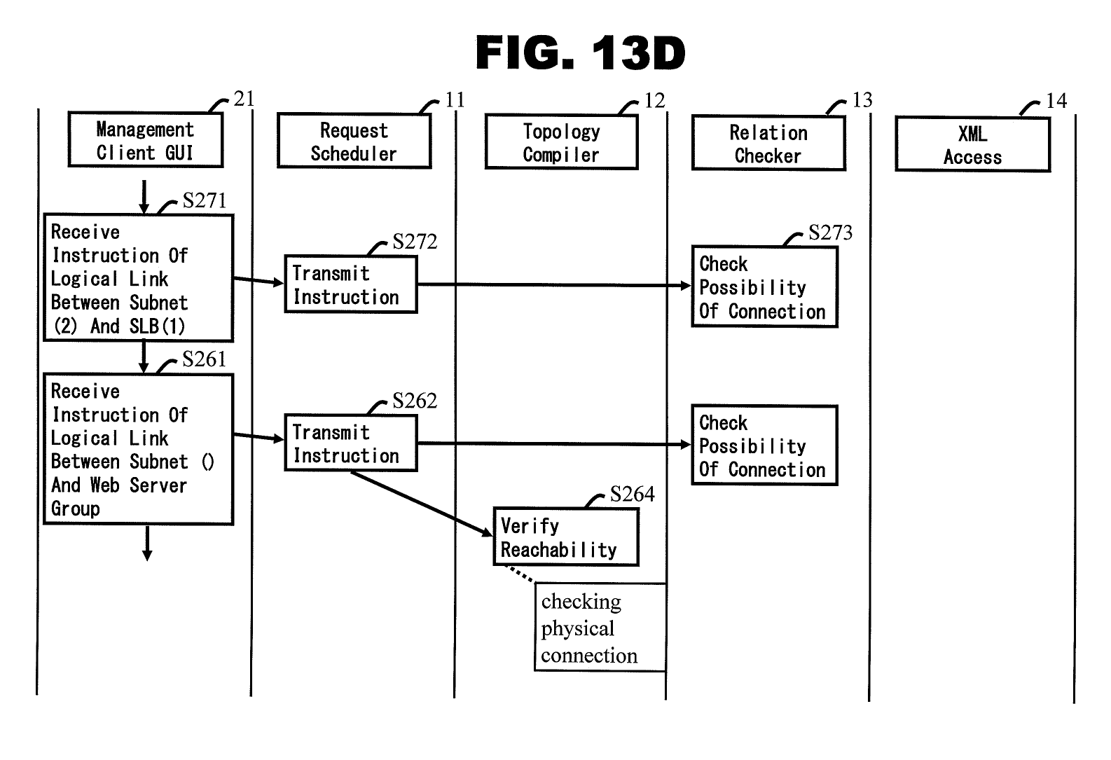

FIG. 15 illustrates a setting information example 550 registered for a subnet object and transmitted. As registered information examples, 001 as VLANID, a Subnet (1) as an identity name, a subnet address and a subnet mask are registered. Through the path calculation of the topology compiler 12, SW#a and SW#b are finalized as the SW 70 to configure the subnet. VLAN type is information identifying whether the VLAN is a tag VLAN or a port VLAN.

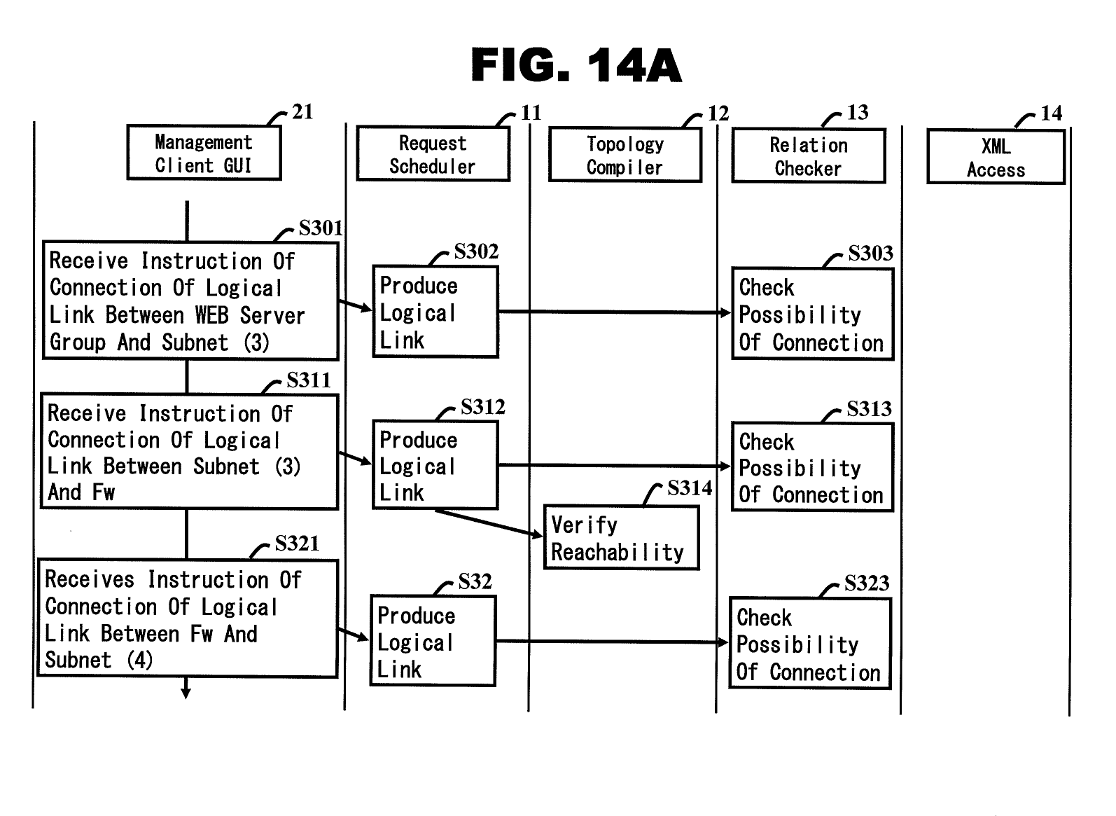

FIG. 16 illustrates a setting information example 560 registered for SLB within a routine object and transmitted.

As registered information examples, SLB as attribute information, SLB(1) as an identity name, 1 as a redundant mode, and a WWEB server group as a server group to be mapped are currently registered.

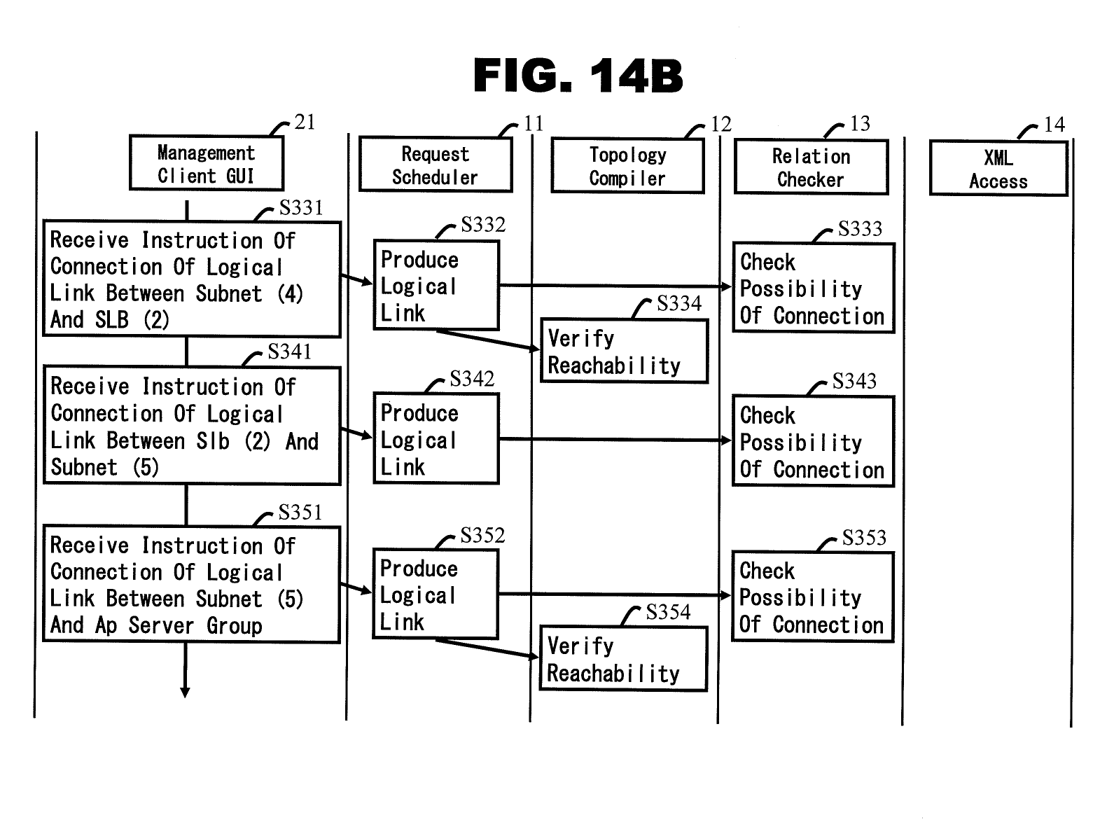

FIG. 17 illustrates an information example 570 of a logical link. Set as the information example 570 of the logical link are an identity name of the logical link, a subnet (1) as a transmission source object, an SLB(1) as a transmission destination object, a port 01 of the SW 70#a as a transmission source connection port, and a port 2 of the SLB 40 as a transmission destination connection port.

Next, the logical setting related to the FW and the SLB(n) as nodes of the network domain 240 is described. If a connection is made in the relationship between server groups and between a server group and an external network beyond the SLB(n) and the FW, the setting of the FW is needed from the standpoint of network security.

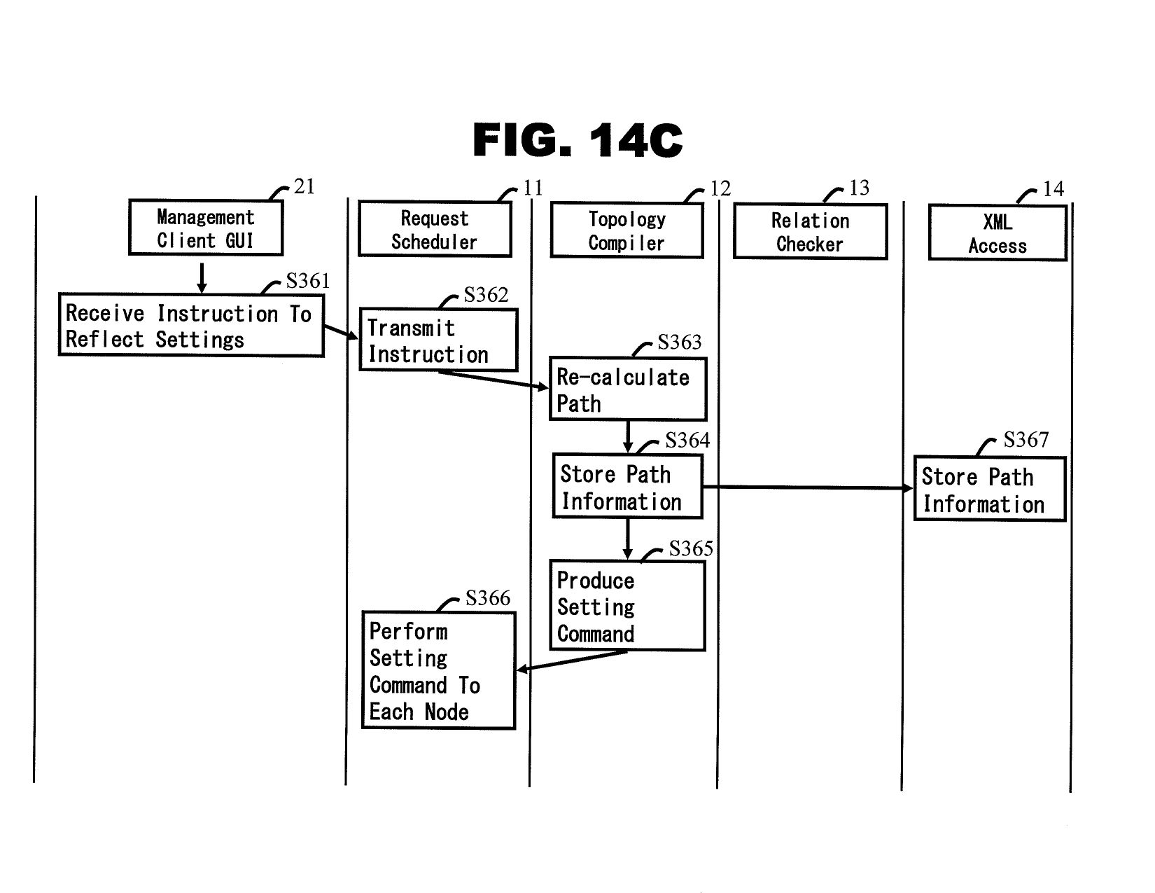

FIG. 18 illustrates a screen example related to a load balancing relation specified on an object registration screen 600. For example, in the logical configuration of FIG. 9, a sharing policy of the SLB(1) needs to be changed in coordination with an increase or a decrease in the number of servers introduced in the WEB server group. To represent this relationship, a load balancing coordination relationship is defined by the management client GUI 21. When the relationship is defined on the screen 600 of the same figure, an IP address representing the server group 200 is also specified together the definition of the relationship. It is not required that the sharing policy of the SLB(1) be in coordination with the sharing policy of the SLB 40(2).

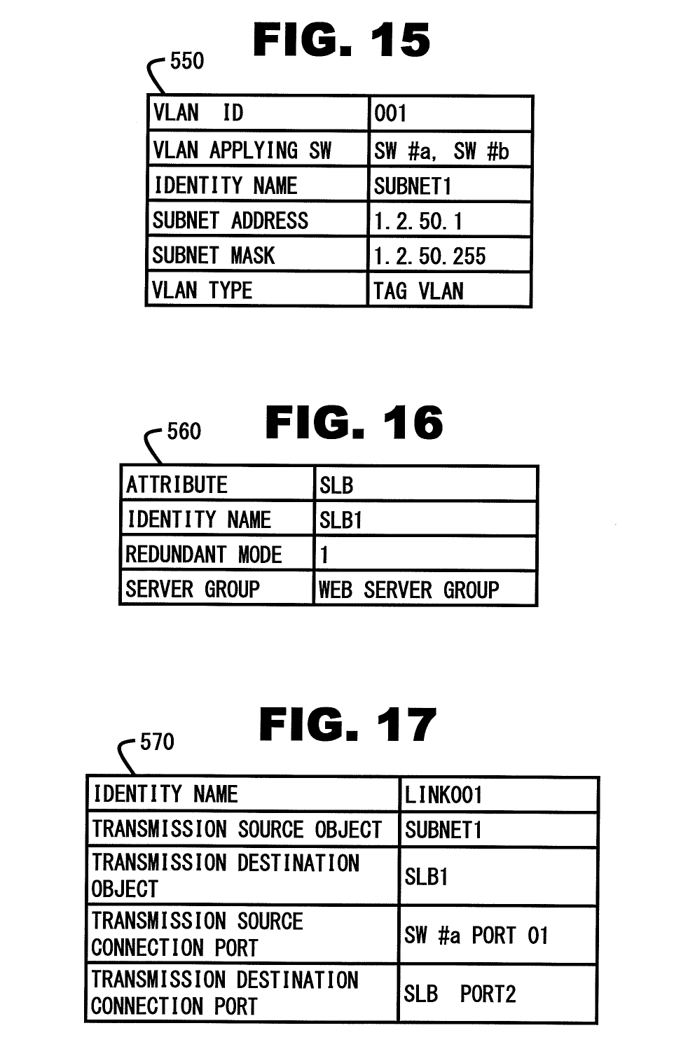

FIG. 19 is a flowchart illustrating a setting process related to load balancing. First, the administrator inputs setting information of the load balancing coordination relation using the management client GUI 21. The setting information of the load balancing refers to information for mapping the server group to the SLB(n), and representative IP address information of the server group with respect to the SLB(n). The administrator also inputs policy information as to how the load balancing is performed in the server group 200.

Upon receiving the above-described setting information from the management client GUI 21 (S401), the topology compiler 12 searches the SLB 40, belonging to the routing object 612 represented by the SLB(1), in accordance with the XML access 14 (S402).

An instruction to execute a setting modification of reflecting in a detected SLB 40 apparatus the representative address information and the load balancing policy information is set to be the setting command 15 (S403), and the setting command 15 issues a control command to the apparatus.

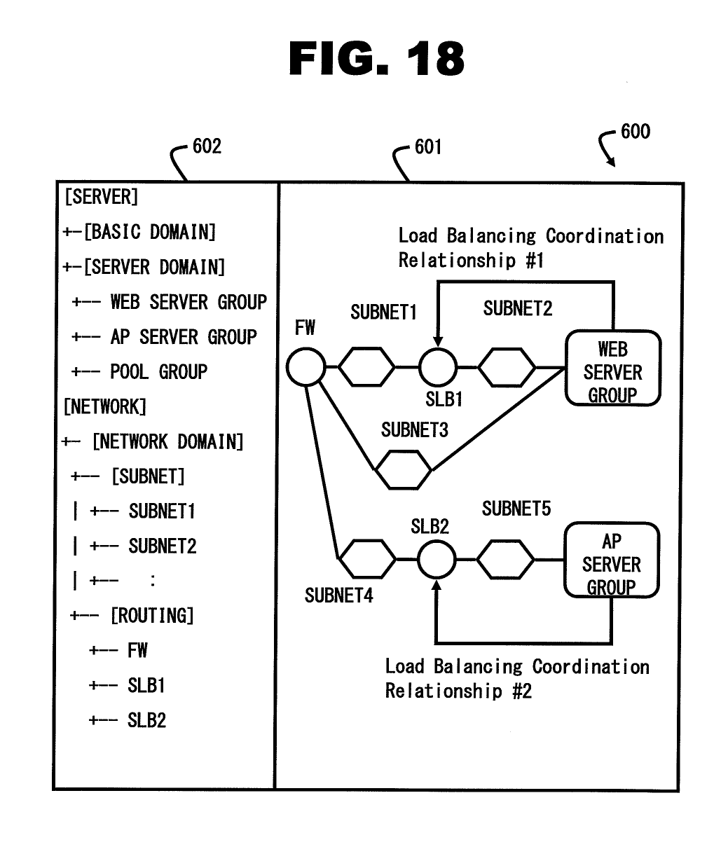

FIG. 20 illustrates a structure example 580 of the setting information to be transmitted to an SLB40 apparatus.

One example of the structure example 580 of the setting information includes a representative IP of a server group for the SLB 40, and a server and a load ratio to the server, as the load balancing policy to the server contained in the server group.

Also, if there is an increase or a decrease in the number of servers contained in the server group 200, the following process is performed.

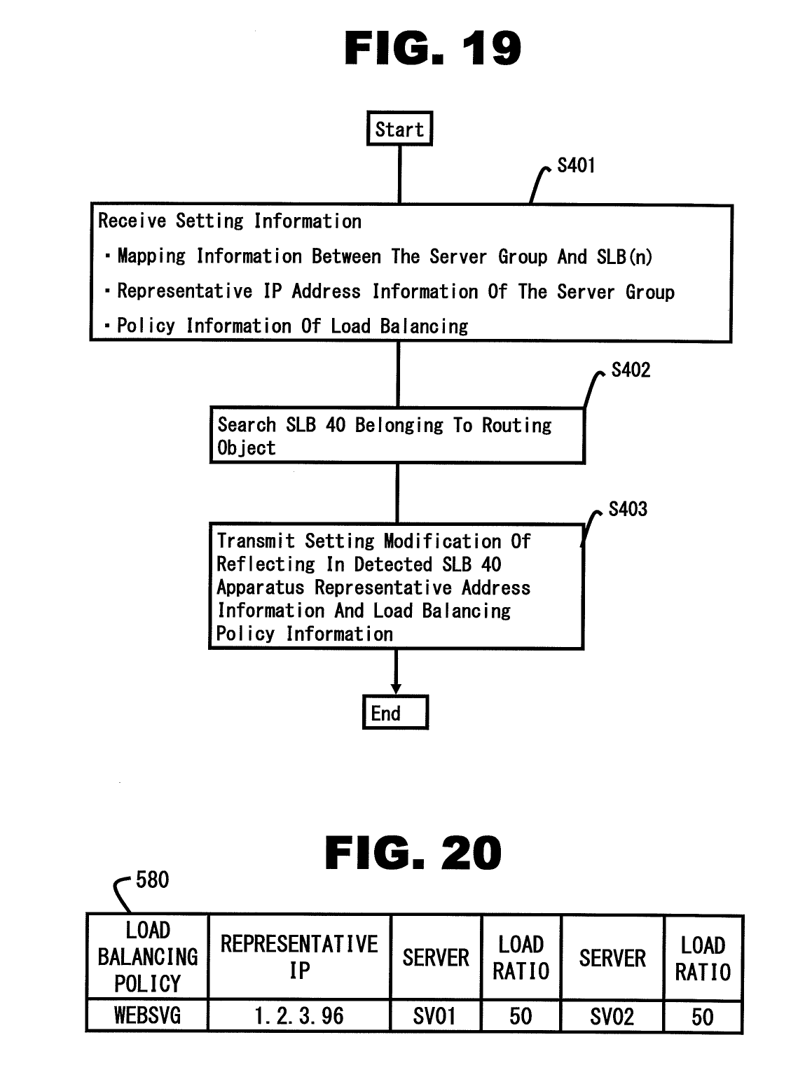

FIG. 21 is a flowchart in which there is an increase or a decrease in the number of the servers contained in a server group 200. If there is modification information related to an increase or a decrease in the number of servers in the server group or modification information of the load balancing policy (S501: Yes), the topology compiler 12 detects from network logical configuration information whether the load balancing is defined on the server group. If the routing object 612 having the load balancing coordination relation defined is present (S502: Yes), an instruction to modify the load balancing policy setting is issued to the SLB 40 apparatus belonging to the routing object 612. The SLB 40 apparatus starts sharing based on the load balancing policy.

As described above, control to modify the load balancing policy on the network in coordination with the operation of the server can be specified in designing on the object registration window 600.

Discussed next are a method of setting a pass permission to the FW and a method of performing the pass permission setting in coordination with the setting of an increase or a decrease in the number of servers within the server group 200.

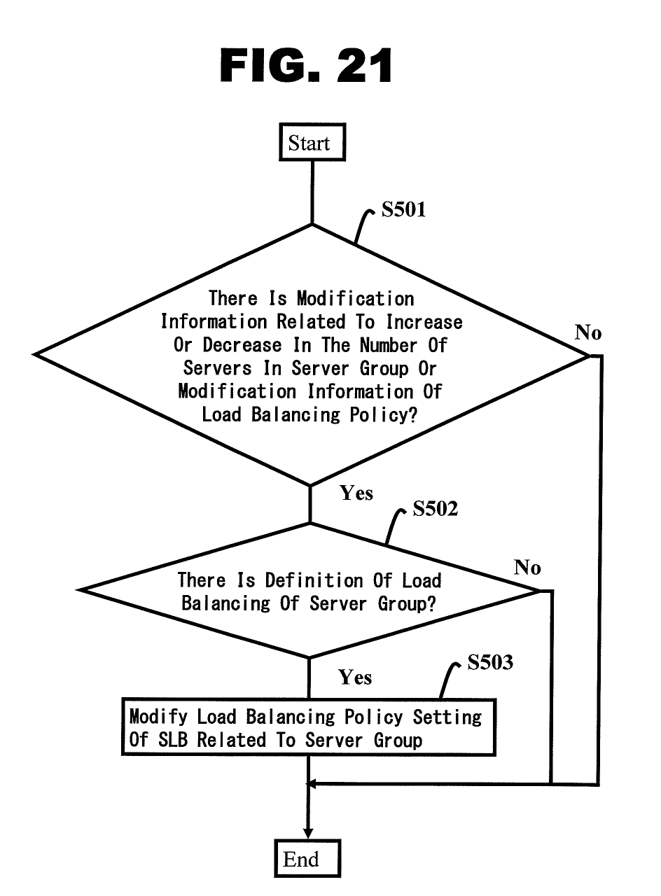

FIG. 22 is a flowchart illustrating a pass permission setting to the FW between a server group and an external network. To set the pass permission to the FW, the administrator selects a target FW on the management client GUI 21, and sets a pass permission coordination. The administrator inputs information related to a related target for connection and port information for permitting connection, on a network configuration screen of the management client GUI 21.

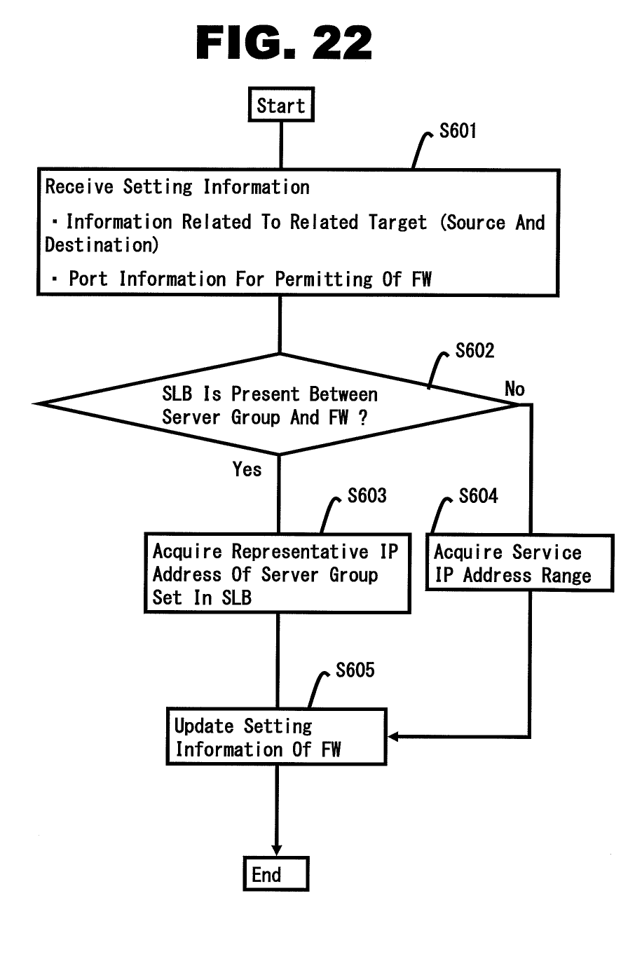

FIG. 23 illustrates a network configuration screen example in which a pass permission is set between external networks. FIG. 23 illustrates a state in which an input screen of pass permission coordination information is output for an FW object when the administrator specifies the FW object. The topology compiler 12 determines from information input (s601) whether an SLB is present between the server group and the FW (s602). If the SLB is present (s602: Yes), the topology compiler 12 acquires a representative IP address of the server group set in the SLB (s603). On the other hand, if no SLB is present between the server group and the FW (s602: No), the administrator inputs a service IP address range (s604).

The topology compiler 12 produces information for updating the setting information of the FW 50 in accordance with the acquired IP address (s605), and transmit setting modification information to the target FW 50 through the setting command 15.

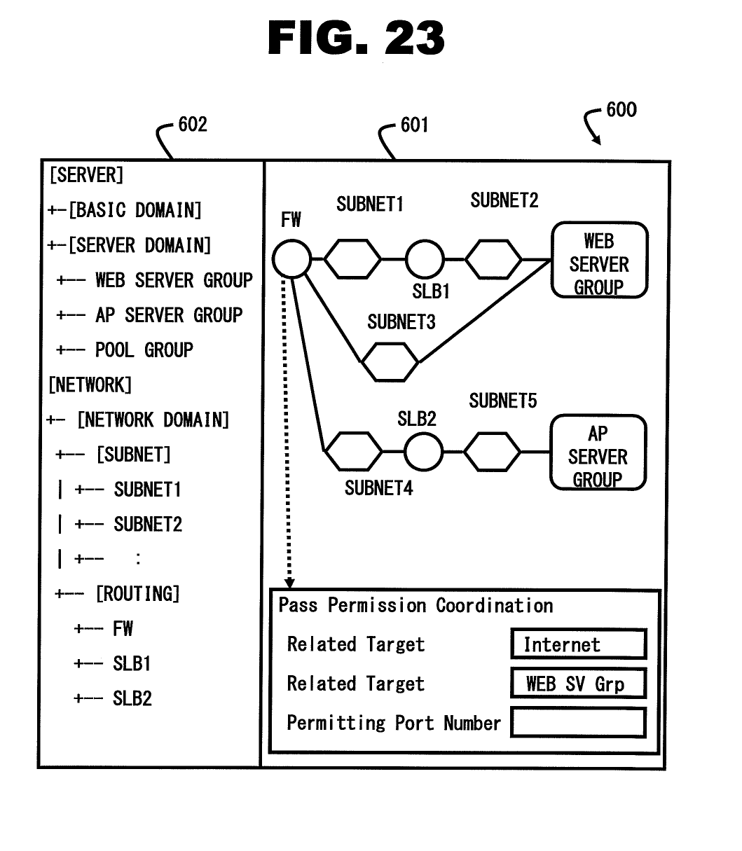

FIG. 24 illustrates an information example (1) 590 to be transmitted to the target FW 50. The information example (1) 590 to be transmitted to the target FW 40 includes in the structure thereof an identity name for permission setting, a transmission source object, a transmission destination object, a transmission source port, and a transmission destination port. In the case of a pass permission between the external network and the server group, the permission setting is performed in two ways. In the example as shown, permission settings 001 and 002 indicate setting information that the SLB 40 related to the server group has a representative IP address, and permission settings 101 and 102 indicate setting information that no SLB 40 is related to the server group or that the SLB 40 has no representative IP address. Further, if the representative IP address is managed by the SLB 40, updating of the setting information of the FW 50 is not necessary in the event that an increase or a decrease takes place in the number of servers within the server group 200 subsequent to setting.

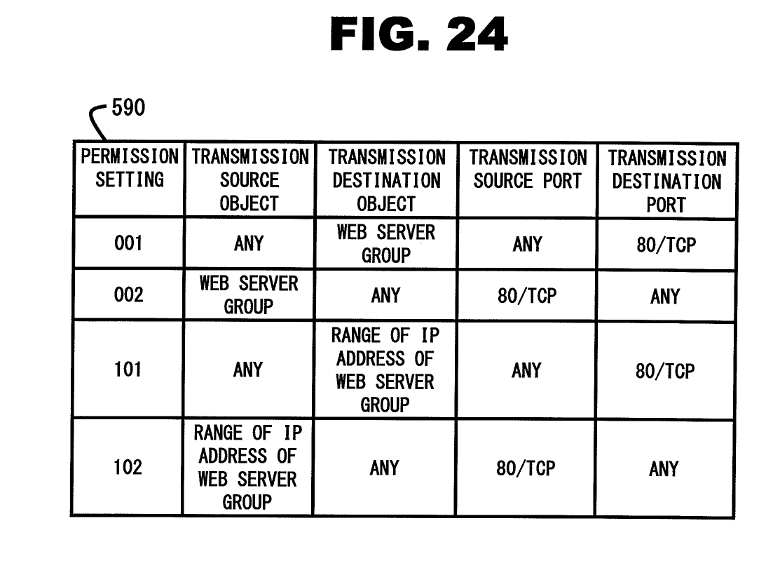

FIG. 25 illustrates a screen example of the pass permission setting between sub groups 200. In the definition of the server group 200, the FW 50 is set as the setting between the WEB server group and the FW in the same manner as in the process with the external network previously described. Since the AP server group has the load balancing coordination relation with the SLB(2), the topology compiler 12 acquires the representative IP of the AP server group from the SLB 40(2), and sets the pass permission for the representative IP address. Further, if the FW 50 is stateful, the FW 50 recognizes communications in return way, and one-way setting is sufficient. On the other hand, in the case of a stateless FW 50, in the case of a stateless FW 50, the FW 50 cannot recognize a return way communication, and a pass permission is set also in the return way.

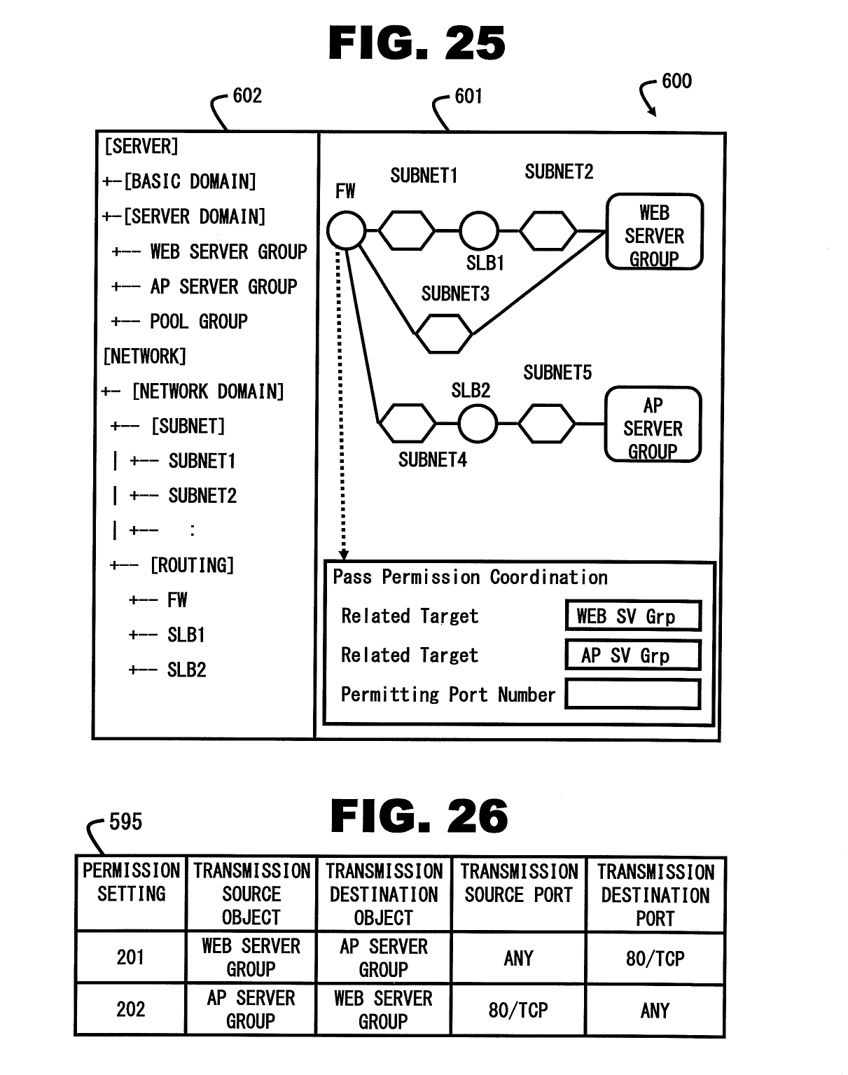

FIG. 26 illustrates an information example (2)595 to be transmitted to the target FW 50. More specifically, in the case of a stateful FW 50 apparatus, a one-way setting is sufficient and a permission setting of 201 only is sufficient. In the case of a stateless setting, a return setting is also necessary, and permission setting needs to be preformed for 201 and 202. Further, if returning from an AP server group to a Web server group via the SLB(1) is specified, return communications are also load-balanced at the SLB(1), and the topology compiler 12 thus sets permission permitting only the representative IP of the WEB server group to the routing object 612 of the FW 50. In this way, determination is made not to modify the FW 50 setting in response to an increase or a decrease in the number of servers in the WEB server group.

A server registration within the server domain 180 is discussed next. Also, a modification of the network configuration in a structure with the physical path multiplexed using the tag VLAN is described. First, the registration of the server to the server group 200 is described.

The server domain 180 and the network domain 240 are connected via a logical link between the WEB server group and the subnet (2), a logical link between the WEB server group and the subnet (3), and a logical link between the AP server group and the subnet (5), on the logical configuration screen of FIG. 9.

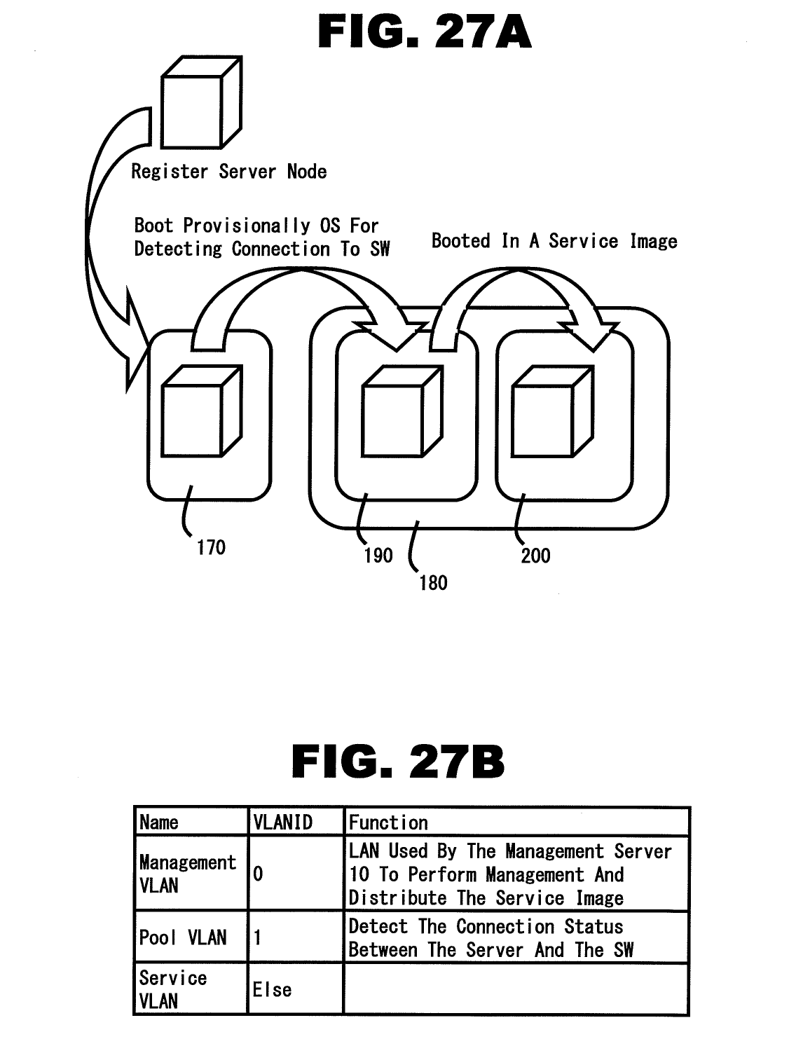

FIG. 27A and FIG. 27B illustrate management structure of the servers. Units for managing server resources are the basic domain 170 and the server domains 180. The server domains 180 are divided between the pool group 190 and the server group 200. The server group 200 contains groups such as the AP server 120, the WEB server 90, the DB server 60, and the load balancing server. On the other hand, one pool group 190 is contained in the server domains 180. When a server is newly registered, the new server is registered in the basic domain 170, and is then moved to the server domain 180. Upon entering the server domain 180, the server is pooled in the pool group 190. When the server finally enters the server group 200, the server is put into a service operation state. To move the server into the server group 200 to be in an operational state, the server needs to be booted in a service image, and adjacent network apparatuses need to be set based on the physical configuration and the logical configuration of the network in response to an instruction from the management server 10.

The VLANs of the present embodiment include three types, namely, a management VLAN, a pool VLAN, and a service VLAN. The example of each VLAN is listed on a table of the same figure, and VLANIDs of these VLANs take different values. The management VLAN is a LAN used by the management server 10 to perform management and distribute the service image. The pool VLAN is used to detect the connection status between the server and the SW 70. The service VLAN is used in actual service. It is noted that the port of the SW 70 to which the server is first connected is set in the management VLAN.

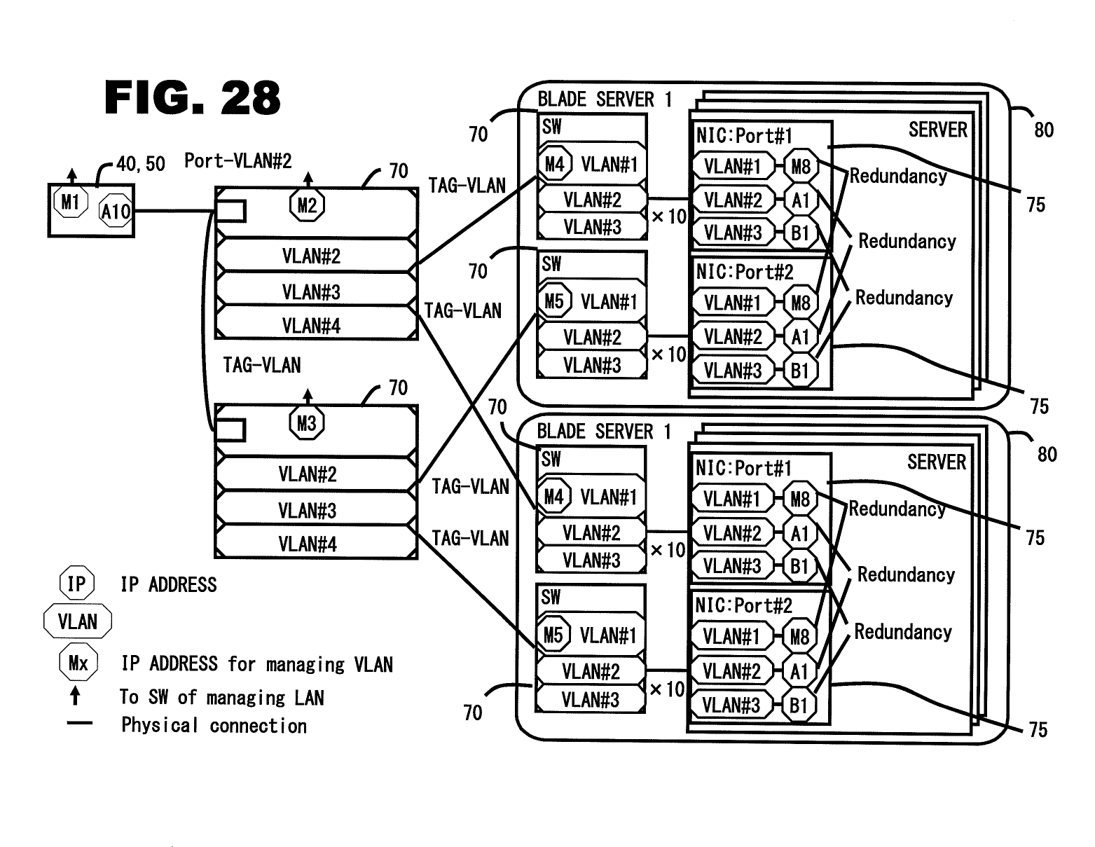

FIG. 28 illustrates a network connection in which a blade server 80 is used.

As illustrated in FIG. 28, a plurality of servers are connected to the blade server 80, and NIC (network interface card) 75 in each server is connected to the SW 70 of the blade server 80. In such a case, the use of the tag VLAN efficiently construct a plurality of networks using the NIC 75 in each server in the blade server 80 and the SW 70 in the blade server 80.

The tag VLAN is a LAN that is constructed based on tag information with a tag attached to a packet. In a network system requiring that the number of servers be increased or decreased depending on status, the server needs to function as the WEB server 90 and the AP server 120. To this end, an environment that permits a program for a Web service and a program for an AP service, having such functions, to be executed needs to be constructed in the server. Furthermore, an OS (operating system) for executing these programs needs to be constructed.

In accordance with the known art, the OS and executing programs are distributed as a master image. The master image is information that contains the OS and an application program for operating the operational service. The master image is image data present for each server group 200. With the image data stored on storage means in the server, the server can operate as the WEB server 90 and the AP server 120. In means (such as PXE boot) that boots the OS not stored on the server by downloading the image of the OS via the network, the tag VLAN is unsupported. In this case, after the image of the OS is distributed to the server via the VLAN, the network setting of the server and the network setting of the adjacent SW 70 are dynamically modified to the tag VLAN so that the network boot can be performed in the network environment of the tag VLAN.

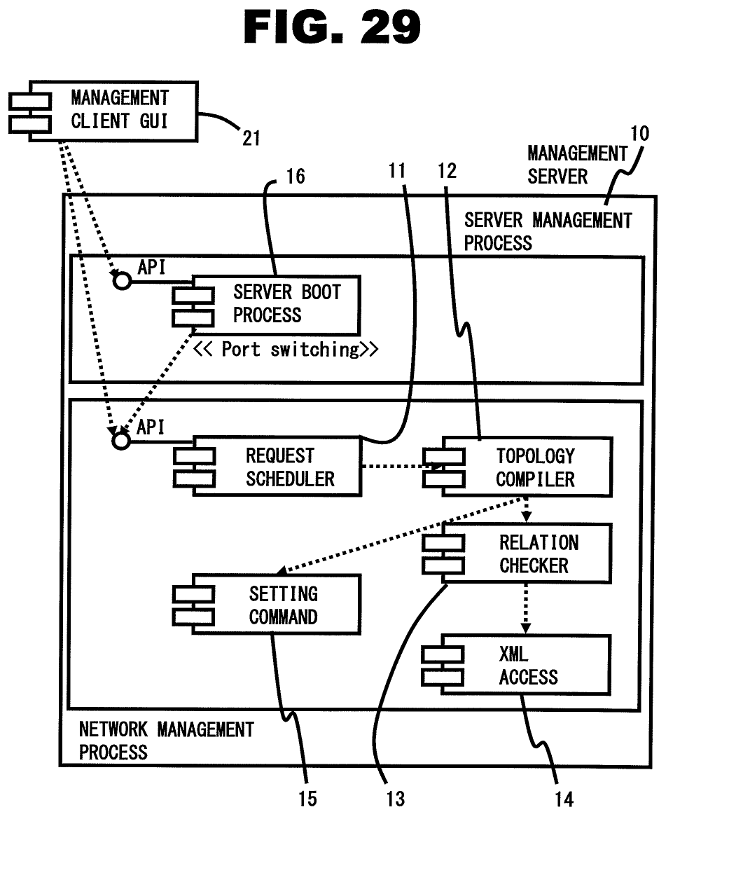

FIG. 29 illustrates a control structure of a management program switching between the port VLAN (tantag VLAN) and tag VLAN. Further to FIG. 12, a server boot process is added. Other information is identical to elements of FIG. 13, and the discussion thereof is omitted. As shown, a server boot process 16 of the management server 10 has a function of modifying the setting of the server to the tag VLAN when the server is added to the network configuration constructed of the tag VLAN, and registered in the server group 200 with the network boot completed.

The flow of the boot process of the server is described below. The invention is based on the premise that the server is network bootable.

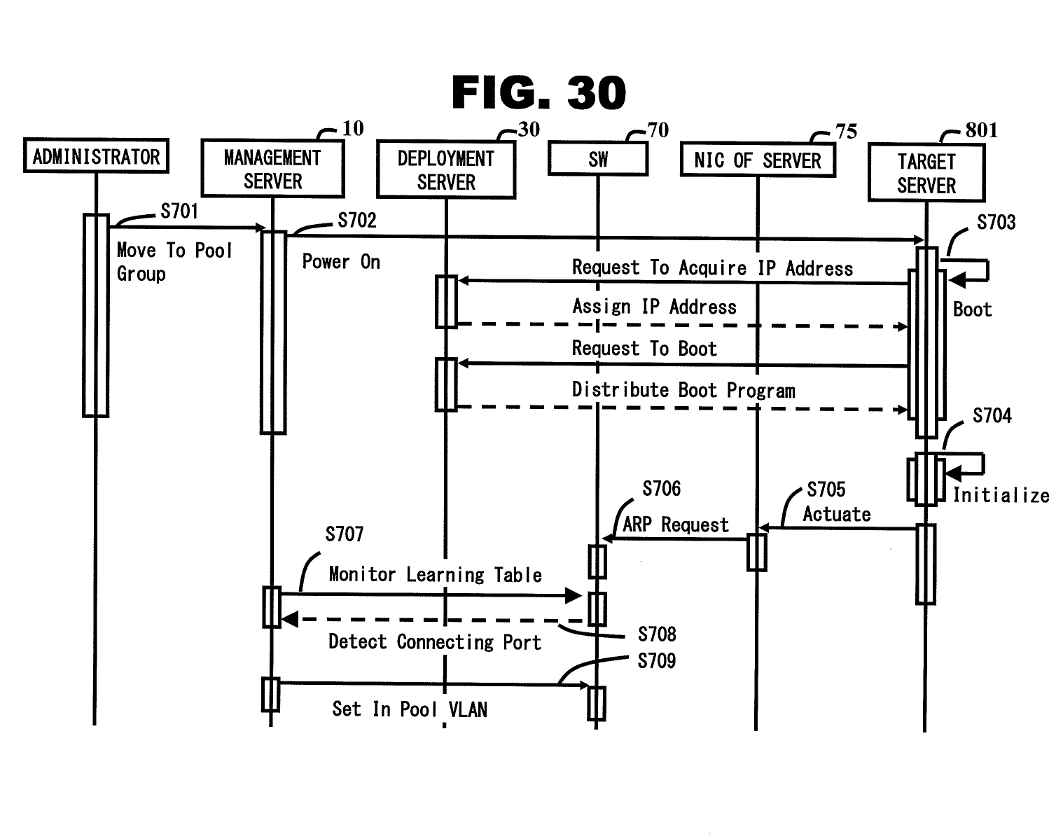

FIG. 30 is a sequence chart of a sub boot at the tag VLAN. The administrator instructs the management client 20 to move the server from the basic domain 170 to the pool group 190 (s701). In response to the received instruction, the management server 10 remotely instructs a target server belonging to the basic domain 170 to power on (s702).

To boot, the target server requests the deployment server 30 to acquire an IP address through DHCP, for example. When the deployment server 30 assigns the IP address to the target server, the target server requests again the deployment server 30 to boot. The deployment server 30 distributes an OS image called a provisional OS that is specialized for the pool server 130 state. The target server starts a boot process based on the received information (s703). After the completion of the boot, the NIC 75 of the server is actuated (s705).

The actuated NIC 75 transmits an ARP request to the SW 70 in order to verify the connection on the management VLAN.

The ARP is a protocol used to determine from the IP address a physical address (MAC (Media Access Control Address) address). The management server 10 monitors a learning table of the physical address stored by a switch belonging to the network switch node 160 (s706), thereby detecting which port of the SW 70 the NIC 75 of the server is connected to (s707).

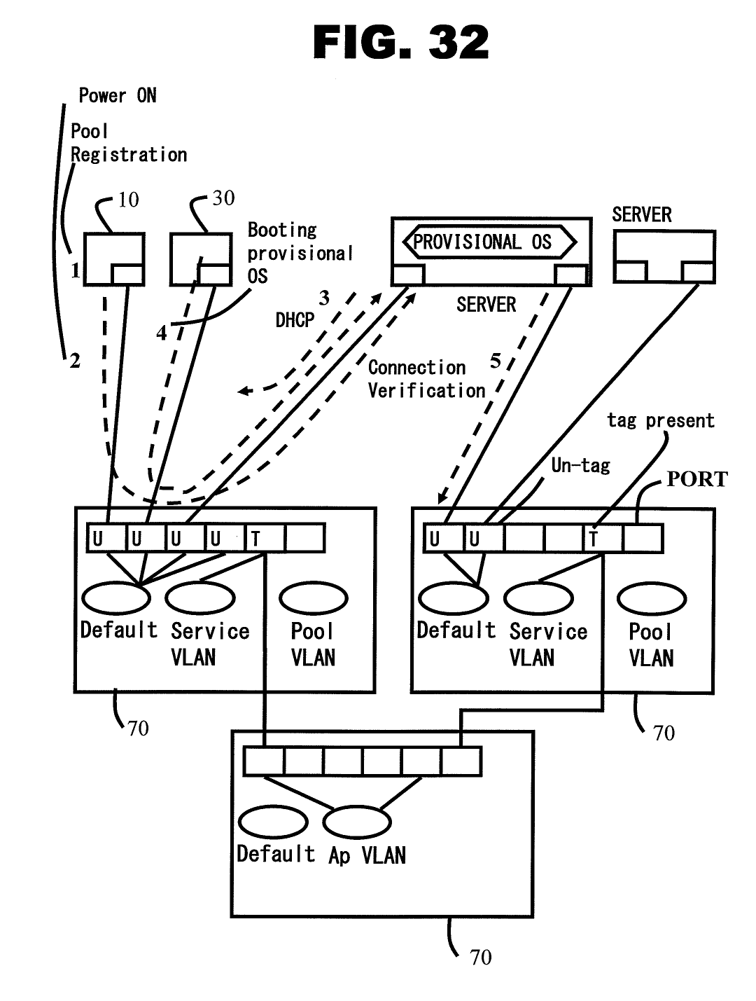

FIG. 32 illustrates a state in which the server has verified connection. As illustrated, “U (port VLAN)” and “T (tag VLAN)” are set for each port within the SW 70.

Upon verifying the connection, the management server 10 sets in the pool VLAN the port of the SW 70 connected to another NIC 75 different from the NIC 75 of the management VLAN used for server management (s708).

The pool VLAN is a VLAN not accessing another VLAN. By setting in the pool VLAN the other NIC 75, an unnecessary packet transmission is restricted.

Through the above process, the physical connection between the target server and the SW 70 in the network switch node 160 is detected.

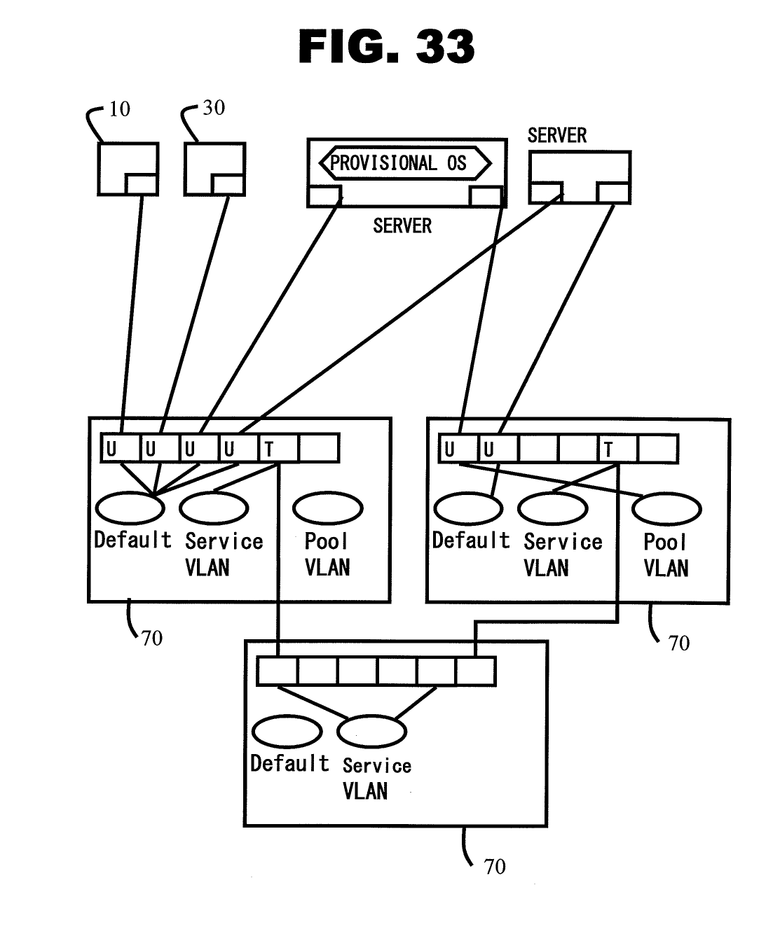

FIG. 33 illustrates a state in which the server is registered in a pool group 190. In this state, the port of the server having the provisional OS registered therewithin is modified from the management VLAN to a pool VLAN logical connection.

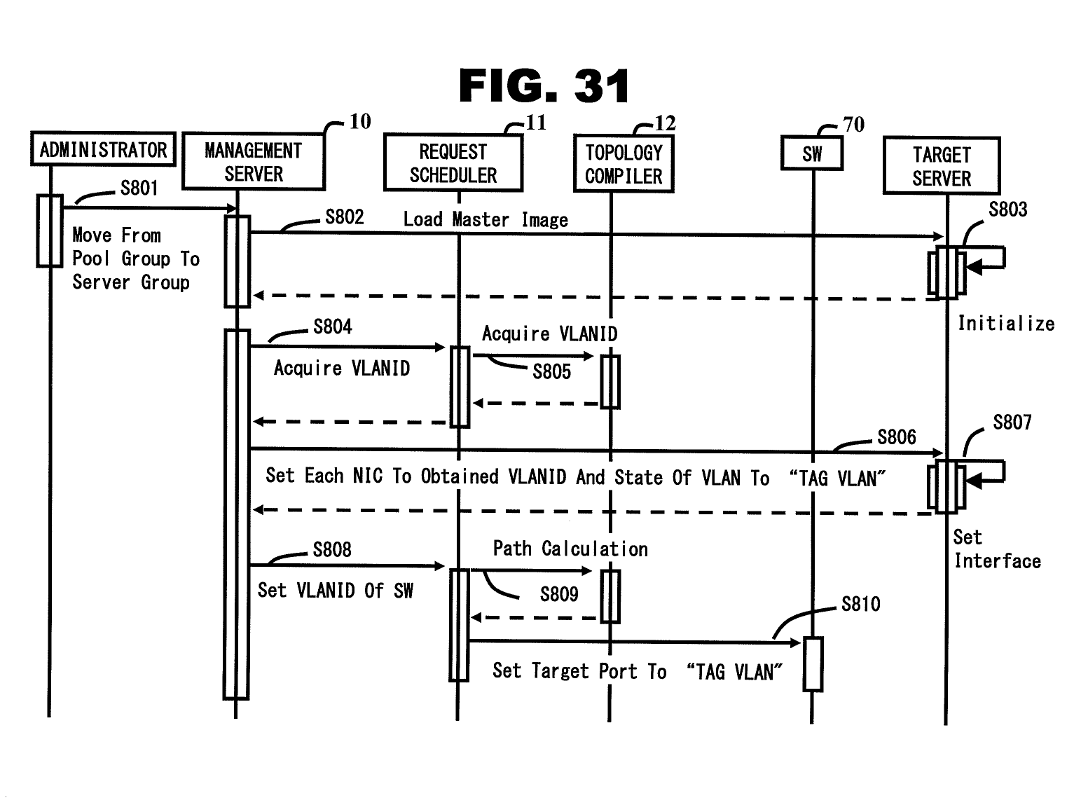

FIG. 31 is an operational flowchart in which switching to the tag VLAN is performed. The server switches the VLAN connected thereto from the tag port VLAN to the tag VLAN at a timing in synchronization with an instruction to move the server from the pool group 190 to the server group 200. An instruction of the administrator to move the target server from the management client 20 to the server group 200 is transmitted to the management server 10 (s801).

The management server 10 sends to the deployment server 30 an instruction to load a master image to the target server and the master image is loaded to the server (s802).

The target server performs an initialization process in accordance with the master image (s803).

Upon completing the initialization process, the target server transmits information to that effect to the management server 10. Upon receiving the information, the management server 10 sends to the request scheduler 11 an acquisition request enquiry to acquire the VLANID to be used in a service network (s804).

The request scheduler 11 asks the topology compiler 12 about the VLANID acquisition request (s805). Upon receiving a reply related to VLANID from the topology compiler 12, the request scheduler 11 supplies the VLANID as a reply to the management server 10. The management server 10 notifies an agent, embedded in the master image of the target server and initiated, of an instruction to set each NIC 75 to the obtained VLANID and the state of the VLAN to “tag present” (s806).

The target server sets an interface based on received information (s807), and supplies a setting completion notification to a management process.

Upon receiving the setting completion notification of the NIC 75 of the target server, the management server 10 issues to the SW 70 to be connected to the target server via the request scheduler 11 an instruction to set VLANID and “tag present” to the connection port of the target server (s808).

Upon receiving the instruction via the request scheduler 11, the topology compiler 12 performs a path calculation to determine the SW 70 to be connected, from the server group 200 the server belongs to and the subnet object 611 (s809), and sets the VLANID and “tag present” on the SW 70 through the setting command 15 (s810). Along with the service VLAN modification, the management VLAN can be switched to “tag present” and connected.

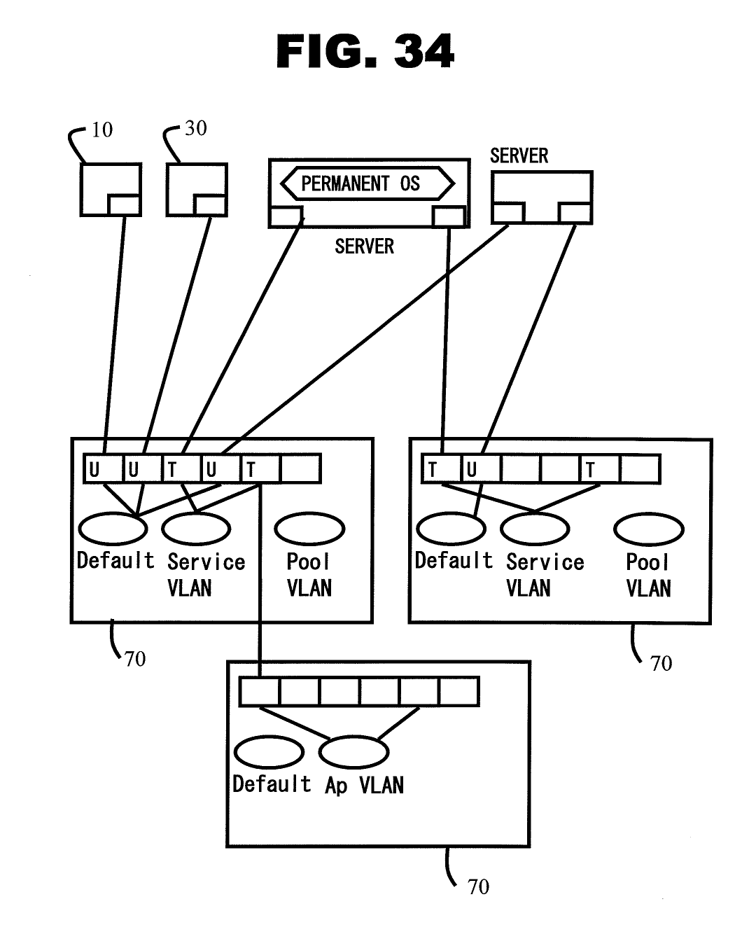

FIG. 34 illustrates a state in which the server is registered in a service VLAN by the tag VLAN. In a port of a server with a permanent OS as service image data registered therein, the logical connection is changed from the pool VLAN to the service VLAN, and the port setting of the SW is also changed from the port VLAN to the tag VLAN.

A system performing autonomously an operation related to a dynamic increase or decrease in the server resources does not operate without setting coordination between the server and the network apparatus. For example, to maintain communications over the network, the setting of the server apparatus as to whether the tag VLAN or the port VLAN is set always needs to be in agreement with the setting of the SW 70 apparatus as to whether the tag VLAN or the port VLAN is set. Furthermore, in the case of the tag VLAN, IDs of assigned tags need to be in agreement with each other. Therefore, although the tag VLAN and the port VLAN can be set by constructing the SW 70 and the server in manual setting, such a setting is extremely difficult.

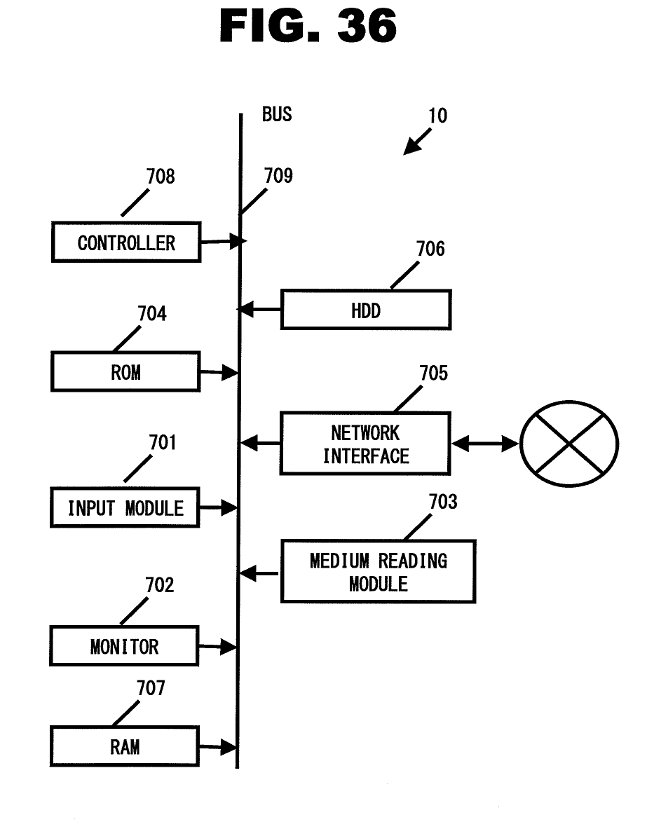

FIG. 36 illustrates a hardware structure of the management server 10 of FIG. 1. The management server 10 includes an input device 701 receiving data input from a user, a monitor 702, a medium reading device 703 for reading a program recorded on a recording medium having recorded a variety of programs, a ROM (Read Only Memory) 704, a network interface 705 for exchanging data with another computer via a network, an HDD (Hard Disk Drive) 706, a RAM (Random Access Memory) 707, and a CPU (Central Processing Unit) 708, all these elements connected via a but 709.

The HDD 706 stores a program for performing the same function as the function of the management server 10, and a management program. The management program may be stored in a collective state or a distributed state.

When the CPU 708 reads the management program from the HDD 706 and executes the read program, the management server 10 functions as the request scheduler 11, the topology compiler 12, the relation checker 13, the XML access 14, and the setting command 15.

The HDD 706 stores the physical connection database storing the physical connection state of the network nodes and the logical connection condition database of the network object.

The CPU 708 stores a variety of data, related to management of the network apparatuses, as the physical connection database and the logical connection condition database, reads the variety of data from the HDD 706, stores the variety of read data onto the RAM 707, and performs a variety of data processes in accordance with information of the physical connection and logical connection stored on the RAM 707.

The invention has been described in detail. The invention is not limited to the above-described embodiments, and it is possible to introduce a variety of modifications and changes without departing from the scope of the invention.

In the above discussion of the embodiments, the tag VLAN is used. The invention is applicable on a technique other than the method of the tag VLAN as long as the technique can logically divide the network. Examples of the technique of dividing logically are WDM (Wavelength Division Multiplex), MPLS (Multi-Protocol Label Switching), etc.

The server has been described as one example. The same technique can manage other network resources.

### INDUSTRIAL APPLICABILITY

The invention may be applied in the field of managing networks.

### REFERENCE NUMERALS

10 Management server
11 Request scheduler
12 Topology compiler
13 Relation checker
14 XML access
15 Setting command
16 Server boot process
20 Management client
21 Management client GUI
30 Deployment server
40 SLB
50 FW
60 DB server
70 SW
75 NIC
80 Blade server
90 WEB server
100 DNS server
110 Load balancing server
120 AP server
130 Pool server
140 Network service node
150 Server node
160 Network switch node
170 Basic domain
180 Server domain
190 Pool group
200 Server group
210 Server category
220 Site
230 Network category
240 Network domain
500 Node management table
510 Physical connection table
520 Mapping table
530 Connection rule table
540 Setting condition table of new objects
550 Setting information example registered for subnet object and transmitted
560 Setting information example registered for SLB and transmitted
570 Information example of logical link
580 Configuration example of SLB setting information
590 Information example (1) to be transmitted to target FW40
595 Information example (2) to be transmitted to target FW 50
611 Subnet object
612 Routing object

1. An apparatus for managing a plurality of nodes connected to a network, comprising:
a first database for storing information of physical connection of the network connecting the plurality of nodes;
a second database for storing condition information for establishing a virtual connection among at least a part of the nodes on the basis of functions of the at least a part of the nodes; and
a controller for executing a process comprising:
receiving an instruction having information of selected functions of the nodes to be used,
detecting at least a part of the nodes having the functions included the instruction, and
determining a virtual connection among the detected nodes on the basis of the information of physical connection stored in the first database and the condition information stored in the second database.

2. The apparatus according to claim 1, wherein the virtual connecting is established by attaching an identifier during information transmission between the nodes, after execution system image data is copied onto a server belonging to a particular LAN to cause the node to perform a desired operation, and a completion notification notifying of copy ending is received from the node,
transmitting the identifier of the virtual connection to the t least a part of the nodes.

3. The apparatus according to claim 2, wherein the network to which the identifier is attached is a tag VLAN.

4. The apparatus according to claim 2, wherein the process further comprises, executing a verification of the physical connection status with the node is performed when the node is included in a backup node group.

5. The apparatus according to claim 1, wherein the node comprises a load balancing apparatus and a sever, and wherein the process further comprises, detects the load balancing apparatus when the instruction having information of the functions having relation between the server and the load balancing apparatus is received.

6. The apparatus according to claim 1, wherein the node comprises a firewall apparatus and a sever, and wherein the process further comprises, detects the firewall apparatus when the instruction having information of the functions to let any server to pass the firewall apparatus is input.
